(19) United States
(12) Patent Application Publication
(10) Pub. No.: US 2024/0146232 A1
(43) Pub. Date: May 2, 2024

(54) FIELD FACTORY FOR SOLAR PANEL PRE-ASSEMBLY

(71) Applicant: The AES Corporation, Arlington, VA (US)

(72) Inventors: Luis Herrera, Bethesda, MD (US); Charles J Reynolds, Fort Collins, CO (US)

(73) Assignee: The AES Corporation, Arlington, VA (US)

(21) Appl. No.: 18/242,931

(22) Filed: Sep. 6, 2023

Related U.S. Application Data
(60) Provisional application No. 63/404,051, filed on Sep. 6, 2022.

(51) Int. Cl. H02S 20/10; H02S 30/10; H02S 40/36

(52) U.S. Cl. CPC H02S 20/10; H02S 30/10; H02S 40/36

(57) ABSTRACT

A method and system for using a field factory for solar panel pre-assembly is disclosed. A solar farm site may be difficult to configure. Thus, a field factory proximate to the site may be used for pre-assembly. As one example, the field factory may be used to configure the solar modules, such as for electrical and/or mechanical configuration, and to test the configuration prior to transport to the solar farm site. At the site, the configured solar modules may be installed onto the torque tubes. As another example, the field factory may be used to configure the solar modules, to mechanically connect the solar modules to the torque tubes to form solar module-torque tube combinations, and to test the combinations prior to transport to the solar farm site. At the site, the solar module-torque tube combinations may be installed, either directly or indirectly, onto piles previously driven into the ground.

### REFERENCE TO RELATED APPLICATION

The present application claims priority to U.S. Provisional Application No. 63/404,051, which is incorporated by reference herein in its entirety.

### FIELD OF THE INVENTION

The present application relates generally to the field of solar farm construction. Specifically, the disclosure relates to performing a pre-assembly at a field factory proximate to a solar farm site and to transporting what is pre-assembled approach to the solar farm site to complete the assembly at the solar farm site.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Solar panels may be installed at a solar farm site. As one example, the solar panels (interchangeably termed solar modules, photovoltaic modules, solar cell panels, a solar electric panels, or a photo-voltaic (PV) modules) may be arranged in parallel rows (e.g., north-south only in the case of solar trackers if the fixed structure east-west is the row direction) and may be installed with a tracking system to pivot and/or track the sun in the course of a day. One way to enable the pivoting or tracking is by using torque tubes, upon which the solar modules may be installed (either directly or via an intermediary structure). Each row at the solar farm site may have a separate torque tube (interchangeably termed torsion tube). In practice, a drive shaft may extend perpendicular to a respective torque tube and have mechanical devices the translate movement of the drive shaft into a rotation or a pivoting of the torque tube. Alternatively, the solar tracker may be self-powered via an electric motor. The control of the drive shaft (and in turn the pivoting of the torque tubes) may be automatic, such as controlled by a controller that tracks the sun and that sends commands, based on the tracking, to the drive shaft to control the pivoting.

The torque tube may connect to and be supported by piles (interchangeably termed posts) via a bearings on the upper end of the piles. Because of the weight of the torque tubes and because of the torque caused by rotating the torque tubes, the piles are typically driven into the ground to provide foundational support.

Thus, the process in configuring the solar farm is very labor intensive and very repetitive, and thereby long (e.g., on the order of 6-12 months). Adding to the difficulty, the solar farm site is typically in a remote, desolate, and hot place, making construction of the solar farm even more difficult. In this regard, the long and labor-intensive construction process is a disincentive to constructing solar farms.

### SUMMARY OF THE INVENTION

In one or some embodiments, a method of installing solar modules at a solar panel site is disclosed. The method includes: driving a set of piles into a ground at the solar panel site; connecting, at the solar panel site, torque tubes to the piles; receiving, at a field factory locationally separate from the solar panel site, solar modules; electrically and mechanically connecting, at the field factory, the solar modules together to form a string or a sub-string of solar modules; electrically testing, at the field factory, the electrical connections in the string or sub-string of solar modules; transporting, from the field factory to the solar panel site, the string or sub-string of solar modules; mechanically connecting, at the solar panel site, the string or sub-string of solar modules to the torque tubes; electrically connecting, at the solar panel site, the string or sub-string of solar modules to other strings of solar modules or other sub-strings of solar modules, or to power electronics; and electrically testing, at the solar panel site, the electrical connections.

In one or some embodiments, a method of installing solar modules at a solar panel site is disclosed. The method includes: driving a set of piles into a ground at the solar panel site; connecting one or more solar modules onto one or more torque tubes to form one or more solar module-torque tube combinations; after forming the one or more solar module-torque tube combinations, connecting the one or more solar module-torque tube combinations to one or more of the piles; and connecting wiring between the one or more solar module-torque tube combinations.

### BRIEF DESCRIPTION OF THE DRAWINGS

The present application is further described in the detailed description which follows, in reference to the noted plurality of drawings by way of non-limiting examples of exemplary implementations, in which like reference numerals represent similar parts throughout the several views of the drawings. In this regard, the appended drawings illustrate only exemplary implementations and are therefore not to be considered limiting of scope, for the disclosure may admit to other equally effective embodiments and applications.

FIG. 1A is a first flow diagram illustrating one example process of using a field factory to construct a solar farm.

FIG. 1B is a second flow diagram illustrating one example process of using a field factory to construct a solar farm.

FIG. 1C is a third flow diagram illustrating one example process of using a field factory to construct a solar farm.

FIG. 2 is a block diagram of one process that may be performed at the field factory.

FIG. 3A is a representation of a truck with a robotic arm for transporting a solar module/torque tube combination from the field factory to the solar farm site.

FIG. 3B is a representation of the truck with the robotic arm for unloading the solar module/torque tube combination transported to the solar farm site.

FIG. 3C is a first representation of the truck with the robotic arm for placing solar module/torque tube combination from the truck onto the piles previously installed in the ground at the solar farm site.

FIG. 3D is a second representation of the truck with the robotic arm for placing solar module/torque tube combination from the truck onto the piles previously installed in the ground at the solar farm site.

FIG. 4A is a flow diagram illustrating another example process of using a field factory to construct a solar farm whereby the solar modules prepared for connection to the torque tubes at the solar farm site.

FIG. 4B is a flow diagram illustrating yet another example process of using a field factory to construct a solar farm whereby the solar modules and the torque tubes are connected at the field factory and transported to the solar farm site.

FIG. 5A is a schematic representation of the solar modules with an example connecting structure prior to installation onto the torque tube/pile previously installed in the ground.

FIG. 5B is a schematic representation of the solar modules with the example connecting structure after installation onto the torque tube/pile previously installed in the ground.

FIG. 6A is a schematic representation of the solar modules/torque tube combination with a first example connecting structure prior to installation onto the pile previously installed in the ground.

FIG. 6B is a schematic representation of the solar modules/torque tube combination with the first example connecting structure after installation onto the pile previously installed in the ground.

FIG. 7A is a schematic representation of the solar modules/torque tube combination with a second example connecting structure prior to installation onto the pile previously installed in the ground.

FIG. 7B is a schematic representation of the solar modules/torque tube combination with the second example connecting structure after installation onto the pile previously installed in the ground.

FIG. 8A is a schematic representation of the torque tube/drive assembly combination prior to installation on pile previously installed in the ground.

FIG. 8B is a schematic representation of the torque tube/drive assembly combination after installation onto the pile previously installed in the ground.

FIG. 9A is a schematic representation of the solar module/damper assembly combination prior to installation on pile previously installed in the ground.

FIG. 9B is a schematic representation of the solar module/damper assembly combination after installation onto the pile previously installed in the ground.

FIG. 10 is a diagram of an exemplary computer system that may be utilized to implement the methods described herein.

### DETAILED DESCRIPTION OF THE INVENTION

The methods, devices, systems, and other features discussed below may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein. Further, variations in the processes described, including the addition, deletion, or rearranging and order of logical operations, may be made without departing from the spirit or scope of the claims as set forth herein.

It is to be understood that the present disclosure is not limited to particular devices or methods, which may, of course, vary. It is also to be understood that the terminology used herein is for the purpose of describing particular embodiments only, and is not intended to be limiting. As used herein, the singular forms “a,” “an,” and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.” The term “coupled” means directly or indirectly connected. The word “exemplary” is used herein to mean “serving as an example, instance, or illustration.” Any aspect described herein as “exemplary” is not necessarily to be construed as preferred or advantageous over other aspects. The term “uniform” means substantially equal for each sub-element, within about ±10% variation.

As used herein, “obtaining” data generally refers to any method or combination of methods of acquiring, collecting, or accessing data, including, for example, directly measuring or sensing a physical property, receiving transmitted data, selecting data from a group of physical sensors, identifying data in a data record, and retrieving data from one or more data libraries.

As used herein, terms such as “continual” and “continuous” generally refer to processes which occur repeatedly over time independent of an external trigger to instigate subsequent repetitions. In some instances, continual processes may repeat in real time, having minimal periods of inactivity between repetitions. In some instances, periods of inactivity may be inherent in the continual process.

If there is any conflict in the usages of a word or term in this specification and one or more patent or other documents that may be incorporated herein by reference, the definitions that are consistent with this specification should be adopted for the purposes of understanding this disclosure.

As discussed in the background, construction of a solar farm may be a long and tedious process. Typically, the piles, or other type of ground-driven or ground-based structure, are installed into the ground to provide foundational support in a ground-mount of the solar modules. After which, the torque tubes (and the attendant drive shaft or drive assembly) may be installed onto the piles, such as via brackets. After which, the solar modules (either individually, in partial strings, or in full strings) may be connected to the torque tubes (either directly or indirectly), as discussed further below.

In particular, solar modules (interchangeably termed solar panels) may be installed at the site in strings (e.g., at least 30 solar modules are both mechanically and electrically connected together in a single string), with multiple strings (such as at least 5 strings, at least 6 strings, at least 7 strings, etc.) connected together to a junction box. Further, in one embodiment, the solar modules may first be connected to each other (either comprising partial strings or full strings), both mechanically via clips and to a supporting structure (e.g., a skeleton structure, interchangeably termed a skeleton or a rail, discussed further below) and electrically via wiring, after which the solar modules/skeleton is connected to the torque tubes (e.g., the skeleton is physically connected to the torque tubes). In this way, the solar modules may be connected indirectly to the torque tubes. In another embodiment, the solar modules may be connected directly to the torque tubes. For example, the solar modules, either individually (each solar module is first connected via one or more torque tube clamps to the torque tube, and then connected to an adjacent solar module via one or more solar module clamps) or combined (multiple solar module combination already clamped together with solar module clamps are first connected via one or more torque tube clamps to the torque tube, and then connected to an adjacent multiple solar module combination via one or more solar module clamps). The solar modules may further be connected electrically to one another (e.g., either before or after direct connection to the torque tubes).

Various electrical connections amongst the solar modules are contemplated. In particular, to have a functioning solar panel site, the solar modules may be wired together to create an electrical circuit through which current will flow (e.g., the solar module converts sunlight into electricity, resulting in the current flowing). Ultimately, the solar modules may be wired to panels (or junction boxes) or other types of power electronics. The DC power generated by the solar modules may be converted to AC power for use in the grid or for use proximate to the solar panel site. Thus, in one or some embodiments, the solar modules electrically connected together may be referred to as stringing, resulting in solar panel strings.

Various types of stringing are contemplated, including series stringing, parallel stringing, and a combination of series and parallel stringing. By way of example, in one or some embodiments, an “array” may comprise several strings electrically connected in parallel to each other. Further, the solar modules may include a positive terminal and a negative terminal. When stringing in series the wire from the positive terminal of one solar panel is connected to the negative terminal of the next panel, and so on. Further, when stringing the solar modules in series, each additional solar module adds to the total voltage of the string, but the current in the string remains the same.

In stringing solar modules in parallel, rather than connecting the positive terminal of one solar module to the negative terminal of the next, when stringing in parallel, the positive terminals of all the solar module on the string are connected to one wire and the negative terminals are all connected to another wire. When stringing panels in parallel, each additional panel increases the current (amperage) of the circuit, however, the voltage of the circuit remains the same (e.g., equivalent to the voltage of each panel). Because of this, if one solar module is heavily shaded, the rest of the solar modules may operate normally with the current of the entire string not being reduced.

Given the different ways in which to install the solar modules at the site, various example sequences of construction are contemplated. One example sequence of construction may be as follows: (1) drive piles into the ground (e.g., in a grid); (2) install bearings and bearing housings on top of the piles; (3) connect torque tubes to the bearings to form multiple torque tube modules; (4) install the torque tube clamps; (5) attach the solar modules directly to the torque tubes via torque tube clamps and then attaching solar modules together via solar module clamps; (6) install wiring between the solar modules to form strings; (7) install wiring between different torque tube modules; and (8) test the electrical connections of the wiring.

Another example sequence of construction may be as follows: (1) drive piles into the ground (e.g., in a grid); (2) install bearings and bearing housings on top of the piles; (3) connect torque tubes to the bearings to form multiple torque tube modules; (4) attach the solar modules to a skeleton and to each other via solar module clamps; (5) electrically connect the solar modules (e.g., install wiring between the solar modules to form strings); (6) install wiring between different torque tube modules; (7) test the electrical connections; and (8) attach the solar modules/skeleton to the torque tubes. Other sequences are contemplated.

These sequences necessitate considerable time at the actual site of the solar farm (interchangeably termed the “site” or the “solar farm site”). As discussed above, in some instances, the actual site of the solar farm may be located in harsh environments, such as the desert, resulting in great difficulty in constructing on-site at the solar farm. Further, there are few economies of scale in constructing in such an environment since the tasks are performed serially.

In this regard, automating part or all of the process may result in a less labor-intensive process. In particular, at least a part of the process may be performed in a controlled environment (e.g., in a field factory), thereby making construction (such as construction that is at least partly automated) easier and more consistent, with better quality control and faster production. Thus, in one or some embodiments, one or more steps of the process are performed at a field factory remote from the actual site of the solar farm. After which, one or more of the remaining steps of the process are performed at the actual site of the solar farm.

Thus, in one or some embodiments, separate from mechanically connecting the solar modules together and/or separate from wiring the solar modules together (e.g., to form partial or complete strings), one or more mechanical structures may be attached to the solar modules at the field factory, with the one or more mechanical structures used at the site in order for the solar modules to connect to one or both of the torque tubes or the piles. In a first embodiment, the piles are installed at the site; after which, the torque tubes are attached to the piles at the site. In this first embodiment, at the field factory, the solar modules may further have attached thereto a mechanical structure that is configured for attachment to the torque tubes (after installation of the torque tubes to the piles at the site). In a second embodiment, the piles are installed at the site; after which, a solar module/torque tube combination, which includes all of the mechanical structure in order to connect to the piles (e.g., the mechanical structure to connect the solar modules to the torque tubes and the mechanical structure to connect the torque tubes to the piles), are attached to the piles at the site. In one or some embodiments, one or more rails and/or clamps may be used in order to interface and/or connect the solar module(s) to the torque tube(s). In this second embodiment, at the field factory, the solar modules may be attached to the torque tubes using this mechanical structure may be attached to both of the solar modules and the torque tubes (e.g., installation at the field factory of both the mechanical structure to connect the solar modules to the torque tubes and the mechanical structure to connect the torque tubes to the piles). In a third embodiment, the piles are installed at the site; after which, a mechanical structure that is configured to attach the torque tubes to the piles, is attached onto the piles at the site. Thereafter, a solar module/torque tube combination, which includes part (but not all) of the mechanical structure in order to connect to the piles, are attached to the mechanical structure at the site. In particular, in this third embodiment, at the field factory, the solar modules may be attached to the torque tubes using the mechanical structure to connect the solar modules to the torque tubes; however, the mechanical structure to connect the torque tubes to the piles is not installed at the field factory. Rather, in this third embodiment, the mechanical structure to connect the torque tubes to the piles is installed at the site.

Thus, in one embodiment, the mechanical structure to connect the solar modules to the torque tubes may comprise a skeleton, as discussed above. As such, in one or some embodiments, any one, any combination, or all of the following steps associated with the solar modules are performed at the field factory: (i) connecting one or more of the solar modules together (such as via clips); (ii) connecting the solar modules to an underlying structure (such as to a skeleton, with the solar modules being aligned); (iii) electrically connecting the solar modules together (e.g., in series or in parallel); (iv) testing the electrical connections between the solar modules; or (v) installing additional hardware associated with the solar modules (e.g., installing sensor(s) to the solar modules in order to determine solar module performance). After performing one or more of steps (i)-(v), the solar modules (which may include the skeleton), may be transported from the field factory to the solar farm site. At which, the solar modules may be attached to the torque tubes, which have already been installed on previously installed piles.

Alternatively, the solar modules may be connected directly to the torque tubes. As such, in one or some embodiments, any one, any combination, or all of the following steps associated with the solar modules are performed at the field factory: (i) connecting the solar modules together (such as via clips); (ii) electrically connecting the solar modules together (e.g., in series or in parallel); (iii) testing the electrical connections between the solar modules; or (iv) installing additional hardware associated with the solar modules (e.g., installing sensor(s) to the solar modules in order to determine solar module performance). After performing one or more of steps (i)-(iv), the solar modules may be transported from the field factory to the solar farm site. At which, the solar modules may be attached to the torque tubes, which have already been installed on previously installed piles.

Separate from attaching the torque tubes to the solar panels (either directly or indirectly), the torque tubes may additionally or alternatively be attached to one or more other structures. As one example, in one or some embodiments, the torque tubes may be attached to a drive assembly (alternatively termed a tracker assembly), which may be configured to move the torque tubes (e.g., rotate the torque tubes) in order to track the sun. In a specific embodiment, the drive assembly may include any one, any combination, or all of: one or more motors; control electronics (e.g., receive a command and responsive thereto, activate the one or more motors to rotate the torque tubes to track the sun; or sense a direction of the sun and responsive thereto, activate the one or more motors to rotate the torque tubes to track the sun); one or more mechanical actuators (e.g., linear actuator, trunnion, or the like); one or more connectors for connecting to the torque tubes; one or more connectors for connecting to the piles; or one or more power sources (e.g., battery, solar panel/electronics). In one or some embodiments, in the field factory, one or more parts of the drive assembly, such as any one, any combination, or all of the following may be assembled therein: one or more motors; one or more mechanical actuators (e.g., linear actuator, trunnion, or the like); one or more connectors for connecting to the torque tubes; or one or more power sources (e.g., battery, solar panel/electronics). In one or some embodiments, part or all of the drive assembly may be pre-assembled at a manufacturer, such as the following: one or more motors; control electronics; one or more mechanical actuators (e.g., linear actuator, trunnion, or the like); one or more connectors for connecting to the torque tubes; and one or more connectors for connecting to the piles. In this regard, in the field factory, the pre-assembled portion of the drive assembly may be connected with the torque tube. Further, the one or more power sources may be mechanically connected and electrically connected (e.g., to the one or more motors) at the field factory as well (e.g., the solar module may be mechanically installed and one or more electrical wires that transit power to one or both of the control electronics and the motor(s) may be installed. In such an embodiment, in the field, in finalizing connection of the drive assembly, in one or some embodiments, only the one or more connectors for the drive assembly need be connected to the piles.

As another example, in one or some embodiments, the torque tubes may be attached to a damper assembly, which may be configured to dampen movement or reduce vibrations of one or more parts of the structure, such as reduce vibrations of the solar modules due to excessive wind. In a specific embodiment, the damper assembly may include any one, any combination, or all of: one or more dampers (e.g., hydraulic damper or the like); one or more mechanical connectors to another device, such as to a structure associated with the solar module(s) (such as the skeleton supporting the solar module(s)); or one or more mechanical connectors to the pile. In one or some embodiments, in the field factory, one or more parts of the damper assembly, such as any one or both of the following, may be assembled therein: one or more dampers and one or more mechanical connectors to another device, such as to the structure associated with the solar module(s). As such, in the field, in finalizing connection of the drive assembly, in one or some embodiments, only the one or more connectors for the damper assembly need be connected to the piles.

As discussed above, the solar modules may be connected via a skeleton to the torque tubes. As such, in one or some embodiments, any one, any combination, or all of the following steps associated with the solar modules and the torque tubes are performed at the field factory: (i) connecting the solar modules together (such as via clips); (ii) connecting the solar modules to an underlying structure (such as a skeleton); (iii) electrically connecting the solar modules together (e.g., in series or in parallel); (iv) testing the electrical connections between the solar modules; (v) installing additional hardware associated with the solar modules (e.g., installing sensor(s) to the solar modules in order to determine solar module performance); or (vi) installing the solar module/skeleton to the torque tubes via clips to generate a solar module/torque tube combination. After performing one or more of steps (i)-(vi), the solar module/torque tube combination, may be transported from the field factory to the solar farm site. At which, the solar module/torque tube combination may be attached to previously installed piles.

Alternatively, the solar modules may be connected directly to the torque tubes. As such, in one or some embodiments, any one, any combination, or all of the following steps associated with the solar modules and the torque tubes are performed at the field factory: (i) connecting the solar modules together (such as via clips); (ii) electrically connecting the solar modules together (e.g., in series or in parallel); (iii) testing the electrical connections between the solar modules; (iv) installing additional hardware associated with the solar modules (e.g., installing sensor(s) to the solar modules in order to determine solar module performance); or (v) installing the solar module to the torque tubes via clips to generate a solar module/torque tube combination. After performing one or more of steps (i)-(v), the solar module/torque tube combination, may be transported from the field factory to the solar farm site. At which, the solar module/torque tube combination may be attached to previously installed piles.

In practice, the field factory (interchangeably termed a pop-up factory or a pre-assembly factory) may be constructed in close proximity to the one or more solar farm farms under construction. In one embodiment, close proximity comprises within driving distance of the solar farm site (e.g., at least 1 mile; less than 1 mile; less than 2 miles; less than 3 miles; less than 4 miles; less than 5 miles; less than 10 miles; less than 20 miles; etc.). Alternatively, close proximity comprises within forklift (such as automated forklift) driving distance (e.g., less than 100 feet; less than 200 feet; less than 300 feet; less than 400 feet; less than 500 feet; less than 1,000 feet; less than 2,000 feet; less than 3,000 feet; less than 4,000 feet; less than 1 mile; etc.). Further, the field factory may perform operations in combination or in concert with operations performed at the solar farm site, with any one, any combination, or all of the following steps being performed:
(i) automated unload of materials at the field factory site (e.g., solar modules such as solar panels and/or solar tracker systems or other solar structures);
(ii) AI-enabled robotic arms assemble different parts at the field factory including any one, any combination, or all of: the solar structures; the tracker (e.g., for tracking the sun), or others, including the assembly of torque tubes;
(iii) at the field factory, position clamps or rails onto the torque tubes, bearings and bearing housings (e.g., the structure used to mount the torque tubes onto piles) on the torque tubes and gears (e.g., used to turn the torque tubes as the trackers track the sun) onto the torque tubes;
(iv) at the field factory, after the torque tube is assembled with clamps, rails, bearings, gears and any other requisite parts, the automated robotic arms install the solar modules onto the torque tube and secure the solar modules in place with the clamps or other mechanisms, as bolts, thereby creating a solar module/torque tube combination;
(v) at the field factory, robotic arms automatically electrically connect a number of solar modules (e.g., in series), creating a string of solar modules;
(vi) at the field factory, automatically install wiring to the string of solar modules;
(vii) at the field factory, automatically test the wiring;
(viii) automatically carry (e.g., using AI enabled, automated forklifts, telehandlers or other machinery) the solar module/torque tube combination from the field factory to its installation place within the solar farm;
(ix) at the solar farm site, automatically drive piles into the ground;
(x) at the solar farm site, automatically connect mating bushings to the piles (if needed to connect to the solar module/torque tube combination)
(xi) at the solar farm site, automatically secure the solar module/torque tube combination via the bearing housings onto the piles;
(xii) at the solar farm site, automatically connect the solar module/torque tube combination to the piles via the bushings (e.g., if mating bushings are already connected to the piles, connect the bushings;
(xiii) at the solar farm site, automatically connect wiring; and
(xiv) at the solar farm site, automatically testing of wiring.

As shown above, various steps may be automatically performed. In this regard, in one embodiment, all of steps (i)-(xiv) may be automatically performed. Alternatively, any one, any combination, or all of steps (i)-(xiv) may be automatically performed. Still alternatively, none of steps (i)-(xiv) are automatically performed with all steps being performed manually.

Further, in one or some embodiments, one or more of the above steps may be performed with one or more jigs (or other alignment tools) for alignment. For example, the solar modules may be positioned or connected to the skeleton using the one or more jigs for proper alignment of the solar modules (e.g., so that the solar modules are squared true). Alternatively, or in addition, the torque tubes and the skeletons may be properly aligned using the one or more jigs. In addition, in one or some embodiments, different actions of configuration may be performed in the field factory versus at the site. For example, at the field factory, alignment may be performed (and optionally no leveling be performed), whereas at the site, leveling is performed (and optionally no alignment be performed). In this regard, the division of tasks between what is performed in the field factory versus at the site may be more efficient.

In one or some embodiments, the field factory may be configured as an assembly line that is composed of one or more stations. For example, one or more stations may perform the functions described above, such as any one, any combination, or all of: (ii); (iii); (iv); (v); or (vii). In this regard, the field factory may comprise a makeshift assembly line in which the various functions described above may be performed at different stations therein.

As shown above, there are one or more differences between the disclosed process and other processes to configure a solar farm including any one, any combination, or all of:
(A) part of the construction process is performed at the field factory and another part of the process of the construction process is performed at the site (e.g., in one instance, the construction of the solar modules are performed at the field factory, and then transported to the site for connection to the torque tubes; in another instance, construction of the solar modules and the torque tubes, both individually, such as in step (ii), and/or collectively, such as in step (iv));
(B) the steps in the process are performed in a different sequence (e.g., inverting the sequence, such as by assembling the solar module and torque tubes together before installing on the piles);
(C) additional steps (such as duplicate steps) are performed (e.g., performing testing of the wiring both at the field factory and at the solar farm site);
(D) certain steps are performed at both the field factory and at the solar farm site (e.g., performing wire testing at the field factory and at the solar farm site); and
(E) one or more automatic operations are performed at one or both of the field factory and the solar farm site.

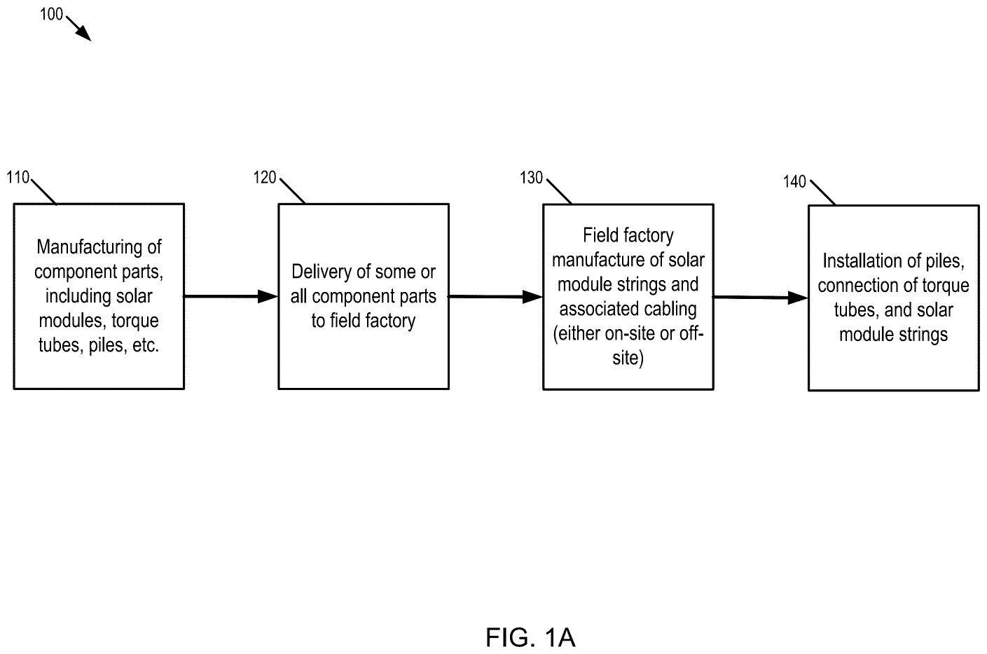

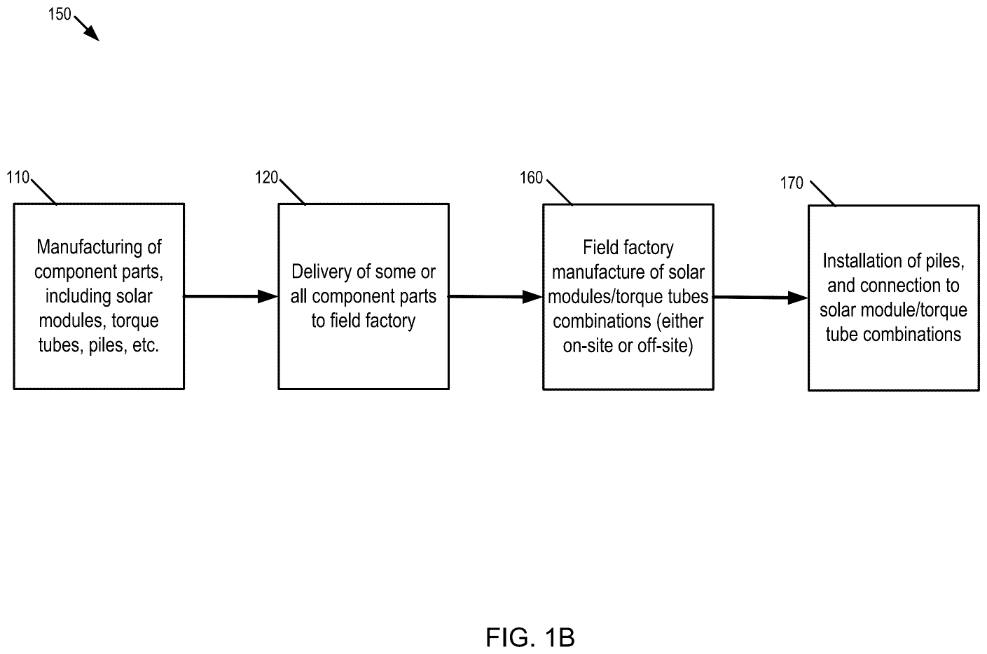

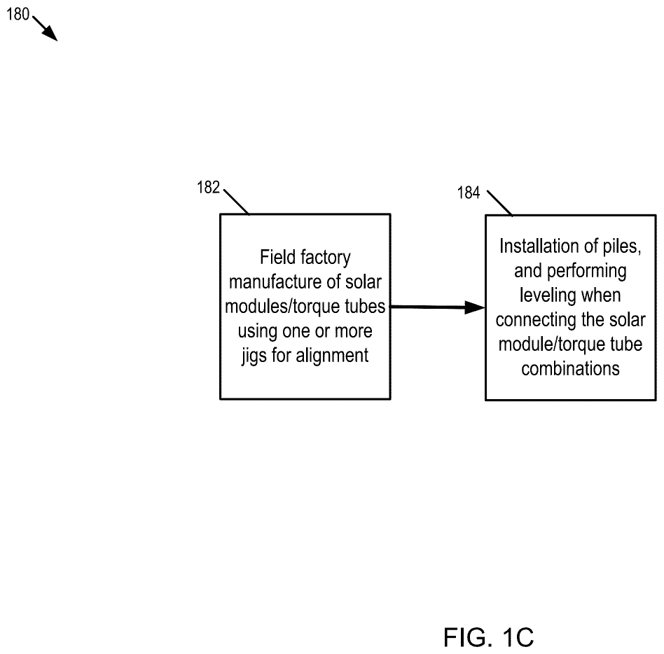

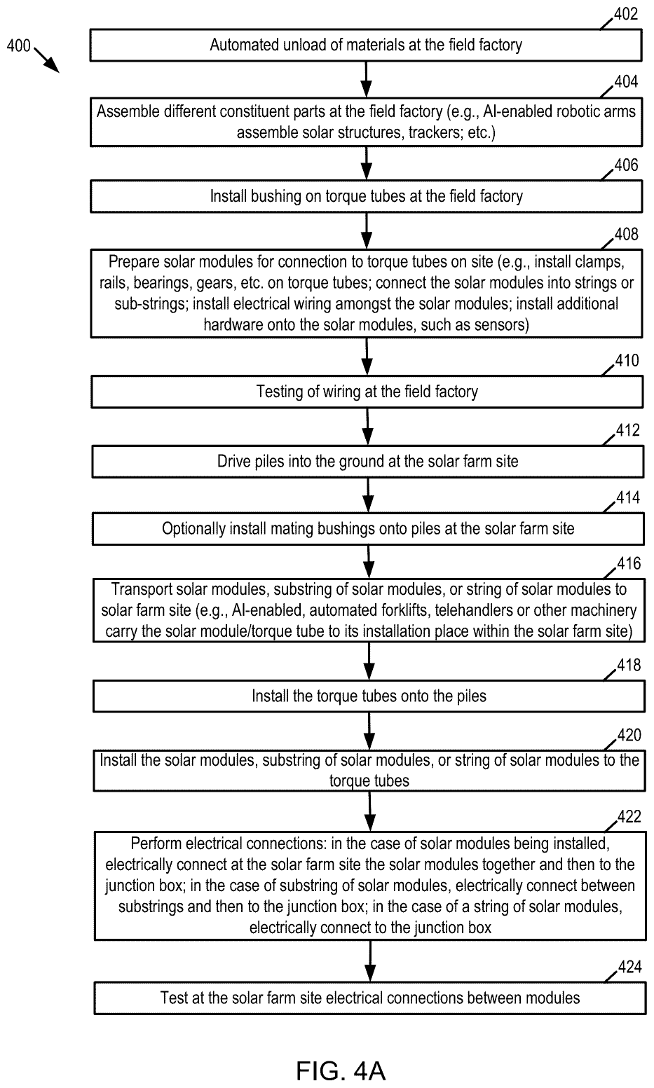

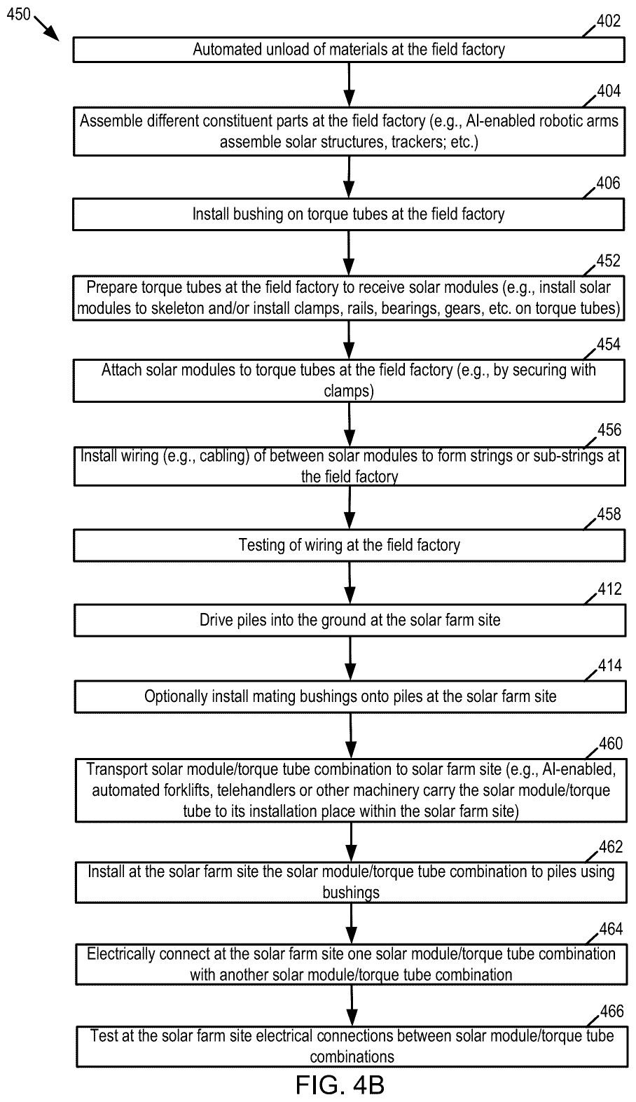

Referring to the figures, FIG. 1A is a first flow diagram 100 illustrating an example process of using a field factory to construct a solar farm. As discussed above, a field factory may be used as part of the overall process of constructing the solar farm. Thus, at 110, the manufacturing of the constituent parts of the solar farm may be performed. As one example, a factory may manufacture the solar modules, with one or a plurality of solar modules comprising a solar panel. As another example, factories may be configured to assemble torque tubes, piles, and the like. In turn, at 120, the constituent parts may be shipped (either directly or via in intermediary) to a field factory. At 130, the field factory may assemble one or more parts, such as the solar modules themselves as shown in FIG. 1A (e.g., performing any one, any combination, or all of: configuring solar modules into strings or sub-strings with electrical connections; configuring the solar modules onto skeletons; installing the solar modules with additional hardware (such as sensor electronics, such as sensors)) or such as the solar module/torque tube combination as shown in FIG. 1B, discussed in more detail below. In one embodiment, the field factory is on-site (e.g., proximate to or at the solar farm site). Alternatively, the field factory is remote or off-site from the solar farm site such that the assembled parts (e.g., the strings of solar modules are transported by truck or the like from the field factory to the solar farm site, which is less than 1 mile away from the field factory, less than 5 miles away from the field factory, or less than 10 miles away from the field factory). After which, the various parts are installed at the solar farm site. For example, at 140, the piles are installed into the ground, after which, the torque tubes are installed, and thereafter the sub-strings or strings of solar modules are installed (either directly or indirectly) onto the torque tubes at the solar farm site. Thus, as shown in FIG. 1, the field factory may be inserted between the manufacturing of the constituent parts of the solar farm and the final installation of the constituent parts at the solar farm site, and thus be an integral part of the overall construction process of the solar farm. Further details of the overall construction process are discussed below with regard to FIGS. 4A-B.

FIG. 1B is a second flow diagram 150 illustrating another example process of using a field factory to construct a solar farm. As discussed above, the solar modules and the torque tubes may be combined at the field factory, with the solar module/torque tube combination thereafter being transported to the site. As such, FIG. 1B is similar to FIG. 1A, with the exception that the solar module is connected (either directly or indirectly) to the torque tubes at the field factory at 160. After which, at 170, the piles (previously driven into the ground) and the solar module/torque tube combinations are installed at the solar farm site. In one or some embodiments, one or more rails and/or clamps may be used in order to interface and/or connect the solar module(s) to the torque tube(s) in order to form the solar module/torque tube combinations.

FIG. 1C is a third flow diagram 180 illustrating yet another example process of using a field factory to construct a solar farm. As discussed above, different functions may be performed at the field factory versus in the field. As one example, alignment functions may be performed in the field factory whereas leveling functions may be performed at the solar farm site. Alternatively, or in addition, the field factory may use one or more jigs to perform the alignment functions. Thus, at 182, the field factory manufactures the solar modules/torque tubes using one or more jigs for alignment. At 184, the piles are installed, and leveling is performed when connecting the solar module/torque tube combinations. Various types of level devices are contemplated, such as an optical instrument that may establish or verify points in a same horizontal plane. Merely by way of example, a rotary laser may be used in which to establish where true level lies. The piles may include one or more fixed slots (e.g., one or more fixed vertical and/or horizontal slots) or one or more adjustable slots (e.g., one or more adjustable vertical and/or horizontal slots). In practice, after true level is identified, the true level may be indicated or designated in a respective fixed slot or by adjusting a respective slot to true level. In turn, the bearing, which may be connected to the respective pile, may be connected to the indicated/designated slot or the adjusted slot.

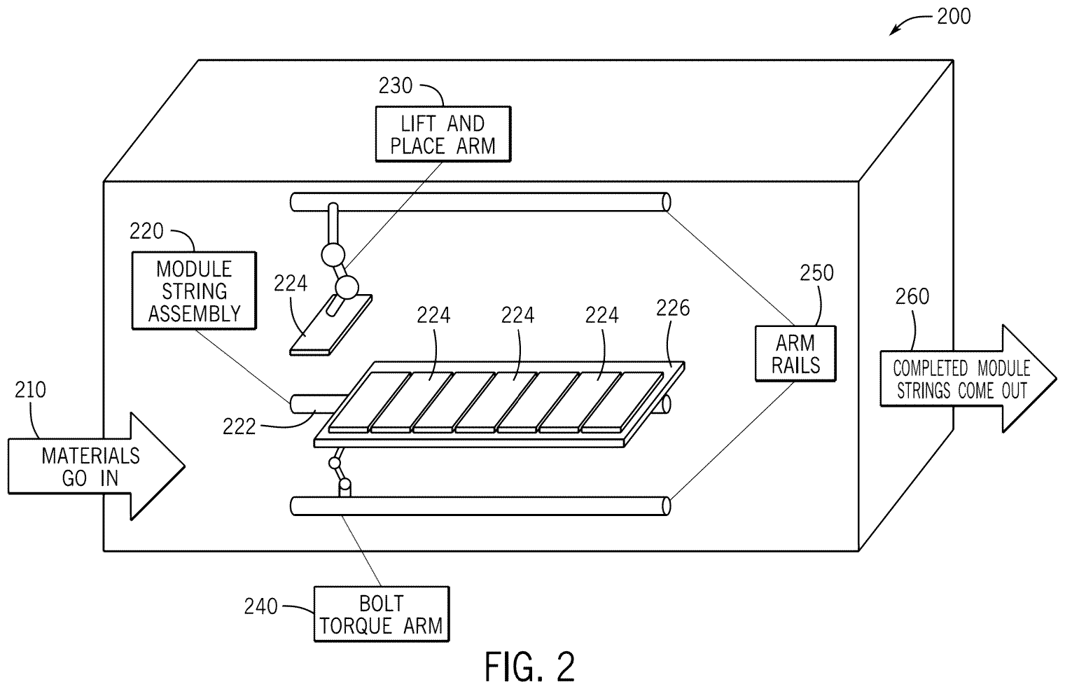

FIG. 2 is a block diagram 200 of one process, such as constructing the solar module strings or solar module substrings, that may be performed at the field factory. In particular, at 210, the materials for the solar module 224 may be received by the field factory. At 220, the module string assembly or module substring assembly is shown in which at 230, a lift and place arm (e.g., using one or more arm rails 250) may be used to place one or more solar modules 224 onto one or more support structures 222. In one or some embodiments, the support structure may comprise a rail, a skeleton, or the like. For alignment purposes, in one or some embodiments, a jib 226 may be used in order to align the one or more solar modules 114 with the one or more support structures 222. At 240, a bolt torque arm (using one or more arm rails 250) is used to bolt or mechanically connect the solar module 224 onto the support structure, thereby forming the substring or string of solar modules 224 for transport from the field factory at 260. One example of an AI-enabled robotic arms configured to assemble different parts, such as the substring or string of solar modules is disclosed in US Patent Application Publication No. 2022/0069770 A1, incorporated by reference herein in its entirety. Alternatively, the field factory may assemble the solar modules to the torque tubes, either directly or via an intermediary (e.g., the skeleton).

FIG. 2 depicts one example of the sequence that may be performed at the field factory. Alternatively, the sequence may be performed in a series of stations, as a manifestation of a makeshift assembly line in the field factory. By way of example, a first station may align (such as by using a first jig) the solar modules with the skeleton, and a second station may align (such as by using a second jig) the skeleton/solar module combination with the torque tube.

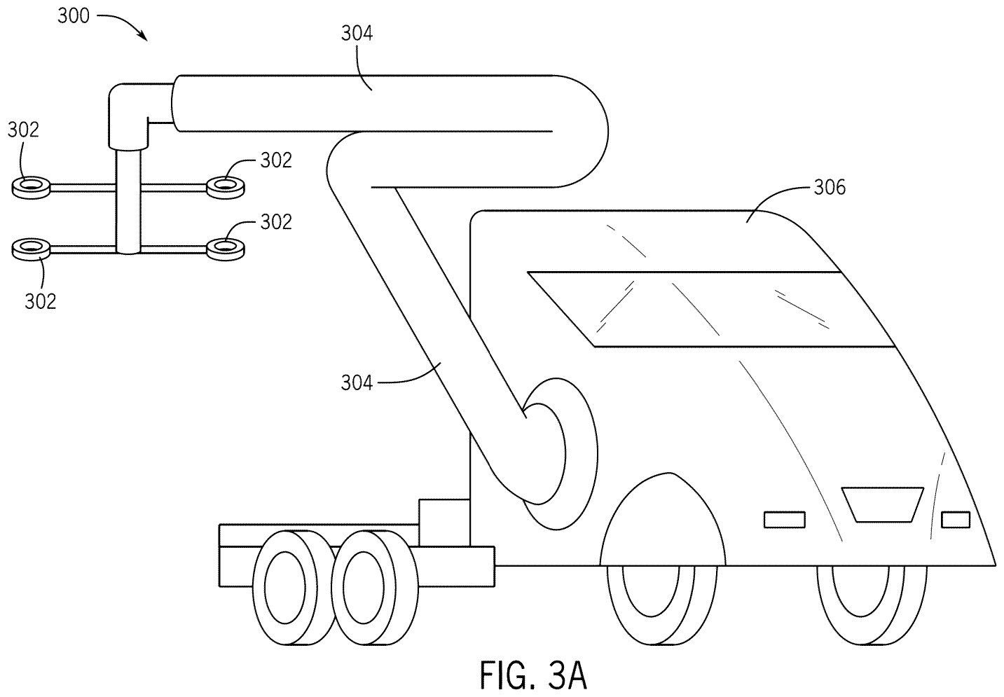

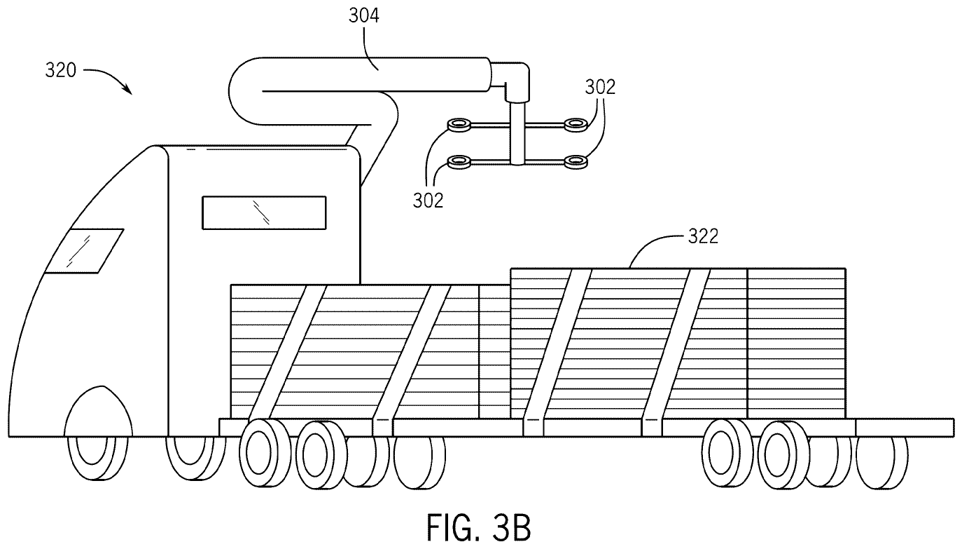

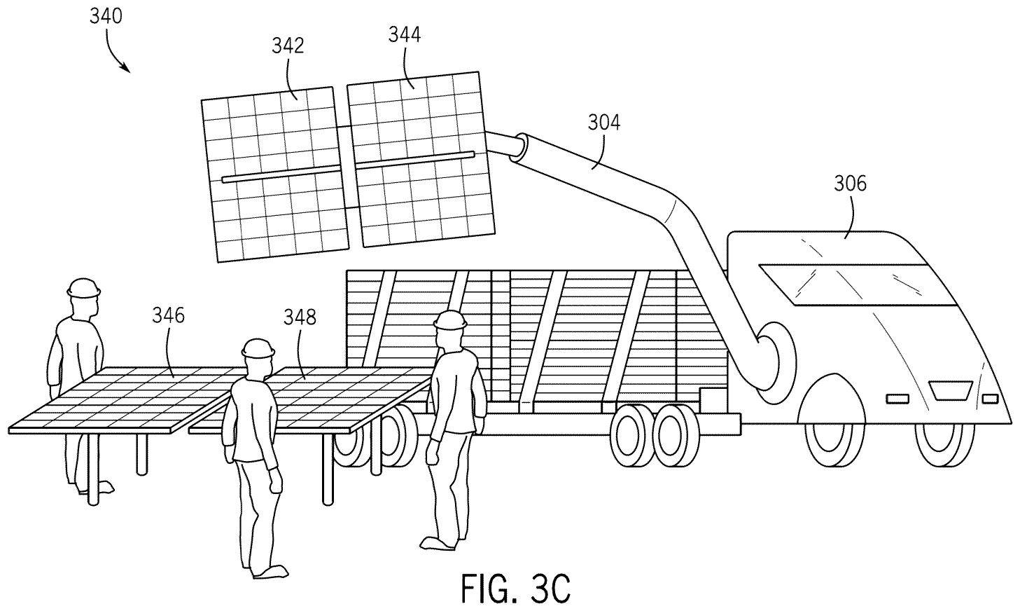

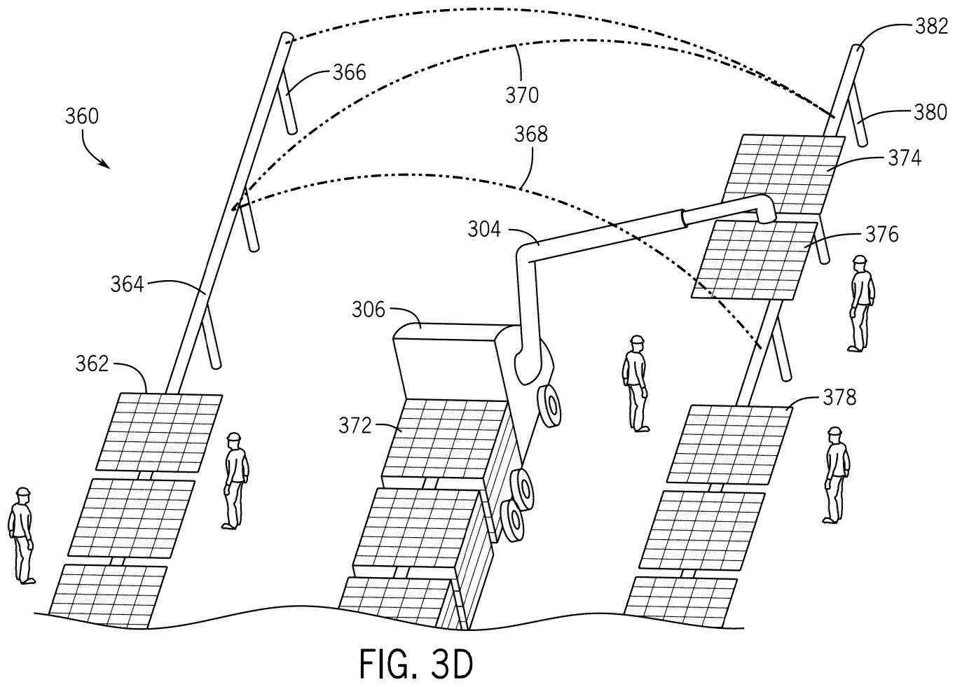

The substring or string of solar modules may be transported from the field factory to the solar farm site in one of several ways. In particular, FIG. 3A illustrates a representation 300 of a truck 306 with a robotic arm 304 and one or more handling structures 302 (e.g., suction cups or the like) as one example for transporting a solar module (such as the string of solar modules) from the field factory to the solar farm site. FIG. 3B is a representation 320 of the truck 306 with the robotic arm 304 for unloading the string of solar modules 322 on a flatbed being transported to the solar farm site.

FIG. 3C is a first representation 340 of the truck 306 with the robotic arm 304 for placing the solar modules (or string of solar modules) (see 342, 344, 346, 348) from the truck 306 onto the piles previously installed in the ground and the torque tubes installed thereon at the solar farm site. FIG. 3D is a second representation 360 of the truck 306 with the robotic arm 304 for placing the solar modules (or string of solar modules) 362, 372, 374, 376, 378 from the truck onto the torque tubes 364, 382 on the piles 366, 380 previously installed in the ground at the solar farm site, with the piles being formed in lines, such as straight lines. As shown, the truck may be positioned between different rows of the torque tubes 364, 382 on the piles 366, 380 so that the truck may alternate placement of the solar modules (or string of solar modules) 362, 372, 374, 376, 378 on either side of the truck, as shown by 368, 370 illustrating movement of robotic arm 304.

FIG. 4A is a flow diagram 400 illustrating another example process of using a field factory to construct a solar farm whereby the solar modules prepared for connection to the torque tubes at the solar farm site. As discussed above, the field factory may perform part of the assembly with the assembled items (e.g., the solar module, the sub-string of solar modules, or the string of solar modules) being transported to the solar farm site for final installation. At 402, the materials may be automatically unloaded at the field factory. At 404, the different constituent parts are assembled at the field factory. For example, AI-enabled robots using robotic arms may assemble the solar structures, the trackers, or the like. Alternatively, the constituent parts may be assembled elsewhere and shipped to the field factory.

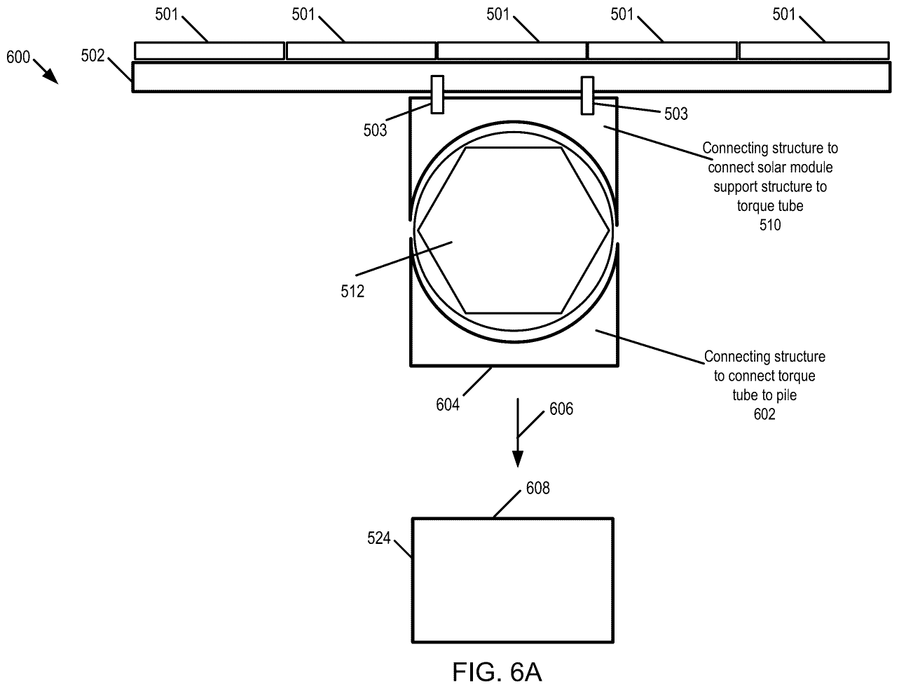

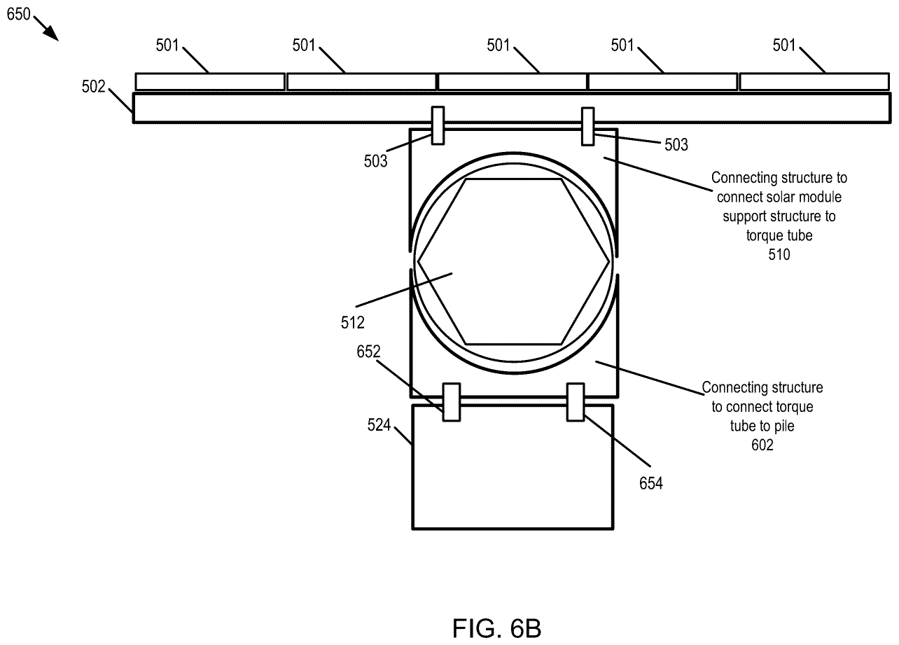

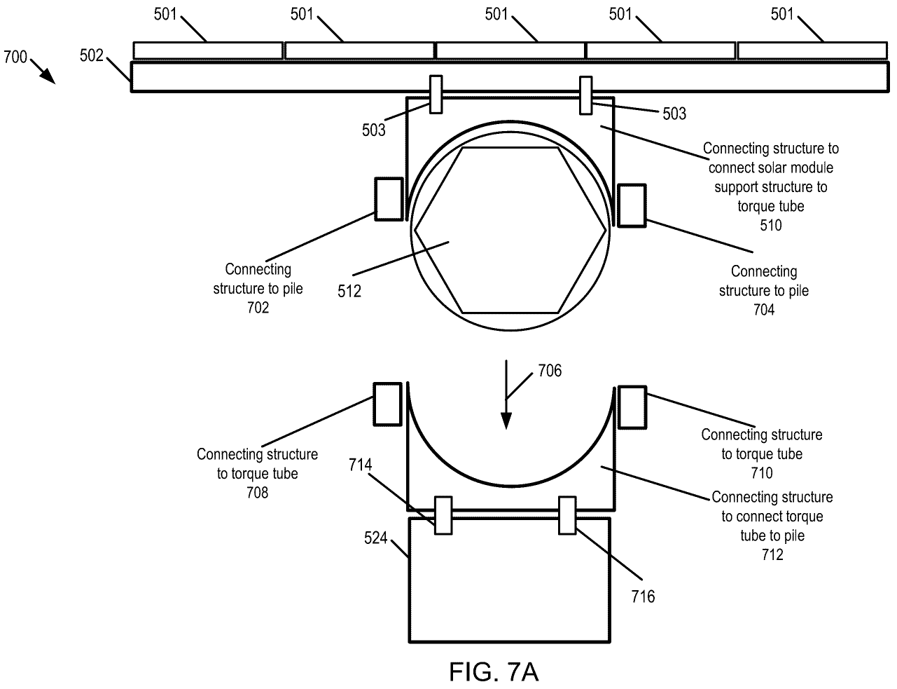

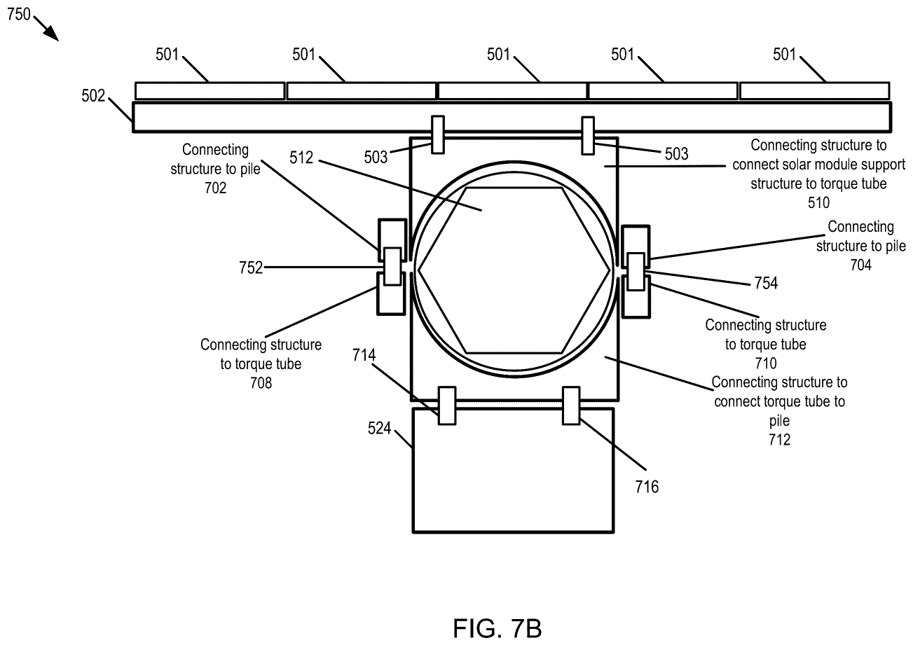

At 406, the bushing (or other type of structure to connect to the piles) are installed on the torque tubes at the field factory. In this regard, in one or some embodiments, the bushing is installed prior to transport to the solar farm site. Various types of connection structures are contemplated to connect the solar module/torque tube combination to the piles. In one embodiment, the connection structure is only installed on the torque tubes. See FIGS. 6A-B. Alternatively, the connection structure is installed on both the torque tubes and the piles. See FIGS. 7A-B. Still alternatively, the connection structure is only installed on the piles. Thus, in one or some embodiments, bushing(s) may first be installed at the field factory onto the torque tube (e.g., a first bushing is installed at the field factory to connect the solar modules to the torque tubes at the field factory and a second bushing is installed onto the torque tubes at the field factory, with the second bushing being connected to the piles at the site). Alternatively, no bushing is installed on the torque tube at the field factory (e.g., in the event that the torque tube uses a bushing to connect to the piles, the bushing may be connected to the torque tube at the solar farm site prior to installation to the piles). Still alternatively, a bushing may be installed at the field factory to connect the solar modules to the torque tubes; however, a bushing (or the like) to connect the torque tubes to the piles may be installed at the site.

At 408, the solar modules are prepared at the field factory for connection to the torque tubes on site, resulting in prepared solar modules, prepared substrings of solar modules, or prepared strings of solar modules. For example, the process may include any one, any combination, or all of: installing clamps, rails, bearings, gears, etc. on torque tubes; mechanically connecting the solar modules onto a mechanical structure (e.g., the mechanical structure may be for a single solar module, may connect a plurality of solar modules to form a sub-string, or may connect a plurality of solar modules to form a string; the mechanical structure (with the solar module(s) attached thereto) may thereafter be transported to the solar farm site and be mechanically connected to the torque tubes at the solar farm site); electrically connecting the solar modules into strings or sub-strings (e.g., installing electrical wiring amongst the solar modules to form strings or substrings); or installing additional hardware onto the solar modules, such as sensors. At 410, the wiring is tested at the field factory. In one embodiment, the testing may be at the string level. Alternatively, or in addition, the testing may be at the sub-string level. Still alternatively, or in addition, the testing may be at the solar module level (e.g., testing the sensors installed in one or more of the solar modules). In the event that the testing identified failures in the wiring, the wiring may be corrected.

At 412, the piles are driven into the ground. Various types of piles are contemplated. For example, any one, any combination, or all of the following pile types may be used: pipe piles; “I” Beams; or helical piles. The piles may be arranged to support a single or multiple solar modules, such as in an array of solar panels. In one or some embodiments, the piles are driven to a preferred depth, such as from 6 to 15 feet.

At 414, mating bushing may optionally be installed onto the piles at the solar farm. For example, certain connection structures, such as bushings, may include a portion installed on the piles, such as illustrated in FIGS. 7A-B. As such, prior to installation of the torque tubes onto the piles, the bushings may be installed onto the piles.

At 416, the solar modules, substring of solar modules, or string of solar modules are transported to solar farm site. For example, AI-enabled, automated forklifts, telehandlers or other machinery may carry the solar modules, substring of solar modules, or string of solar modules to its installation place within the solar farm site. In one or some embodiments, the piles are driven into the ground prior to transport of the solar modules, substring of solar modules, or string of solar modules to the solar farm site. Alternatively, the piles are driven into the ground after transport of the solar modules, substring of solar modules, or string of solar modules to the solar farm site. At 418, the torque tubes are installed onto the piles.

At 420, the solar modules, substring of solar modules, or string of solar modules are installed onto the torque tubes at the solar farm site. At 422, electrical connections are performed including: in the case of the solar modules being installed, electrically connect at the solar farm site the solar modules together and then to the junction box; in the case of substring of solar modules, electrically connect substrings together and then to the junction box; in the case of a string of solar modules, electrically connect to the junction box. At 424, testing is performed at the solar farm site for the electrical connections performed at the solar farm site. Responsive to determining that the testing indicates errors in the wiring, the wiring may be examined and corrected.

FIG. 4B is a flow diagram 450 illustrating yet another example process of using a field factory to construct a solar farm whereby solar module/torque tube combinations are assembled at the field factory. As discussed above, the field factory may perform part of the assembly with the assembled items (e.g., the solar module/torque tube combination) being transported to the solar farm site for final installation. Steps 402, 404, 406 are the same as in FIG. 4A. At 452, the torque tubes are prepared at the field factory to receive solar modules. For example, the process may include installing the solar modules onto a skeleton, and thereafter installing the solar module/skeleton combination onto the torque tubes. Alternatively, or in addition, the process may include installing on the torque tubes any one, any combination, or all of: clamps; rails; bearings; gears; or the like. Alternatively, or in addition, the bushing (or other type of structure to connect to the piles) are installed on the torque tubes after preparing the torque tubes to receive the solar modules. At 454, the solar modules are attached to torque tubes at the field factory to form a solar module/torque tube combination. For example, robots with robotic arms may place the solar modules onto the torque tubes and secure the solar modules to the torque tubes with clamps.

At 456, wiring (e.g., cabling) of different solar modules is installed at the field factory. As one example, after forming the solar module/torque tube combination, the wiring connecting the solar modules within a respective solar module/torque tube combination may be installed. In one embodiment, the solar module/torque tube combination may form a sub-string. As discussed further below, different sub-strings of the solar module/torque tube combination may thereafter be transported to the solar farm site for mechanical installation, wiring installation, and electrical testing. Alternatively, the solar module/torque tube combination may form a string. As discussed further below, different strings of the solar module/torque tube combination may thereafter be transported to the site for mechanical installation, wiring installation, and electrical testing.

At 458, the wiring is tested at the field factory. Various types of testing are contemplated. As one example, the testing may be performed at the string level. Alternatively, or in addition, the testing may be performed at the sub-string level. Still alternatively, or in addition, the testing may be performed at the solar module level. In the event that the testing identifies failures in the wiring, the wiring may be corrected. Steps 412, 414 are the same as described in FIG. 4A.

At 460, the solar module/torque tube combinations are transported to solar farm site. For example, AI-enabled, automated forklifts, telehandlers or other machinery may carry the solar module/torque tube to its installation place within the solar farm site. In one or some embodiments, the piles are driven into the ground prior to transport of the solar module/torque tube combination to the solar farm site. Alternatively, the piles are driven into the ground after transport of the solar module/torque tube combination to the solar farm site.

At 462, the solar module/torque tube combinations are mechanically installed onto the piles using bushings at the solar farm site. At 464, different solar module/torque tube combinations is electrically connected with one another. For example, one solar module in a first solar module/torque tube combination may be electrically connected at the site with another module in a second solar module/torque tube combination. At 466, testing is performed at the solar farm site for the electrical connections between the solar module/torque tube combinations. Again, response to the testing indicating faulty electrical connections, the electrical connections may be examined and corrected.

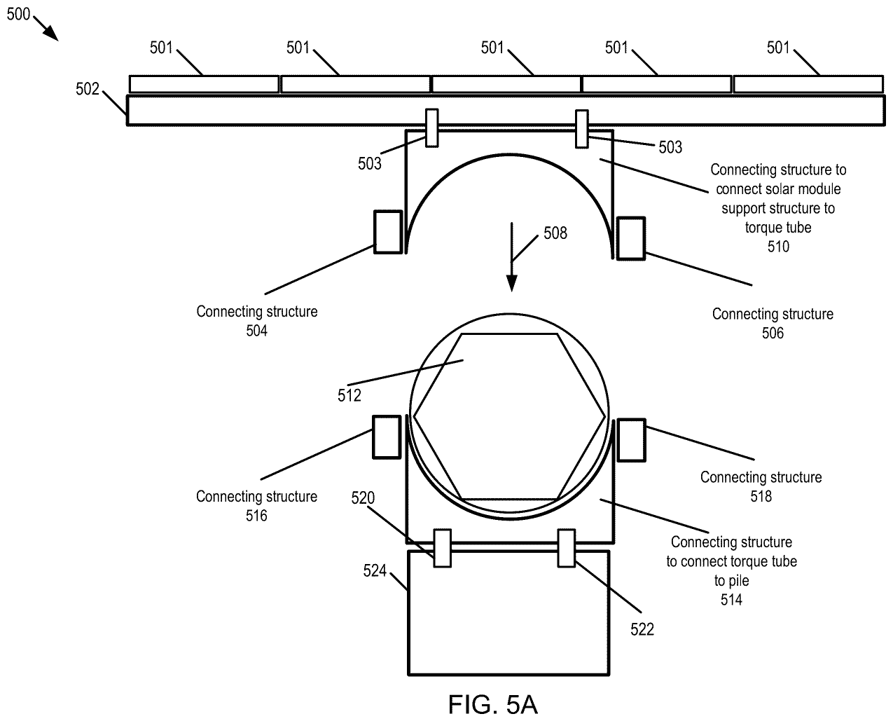

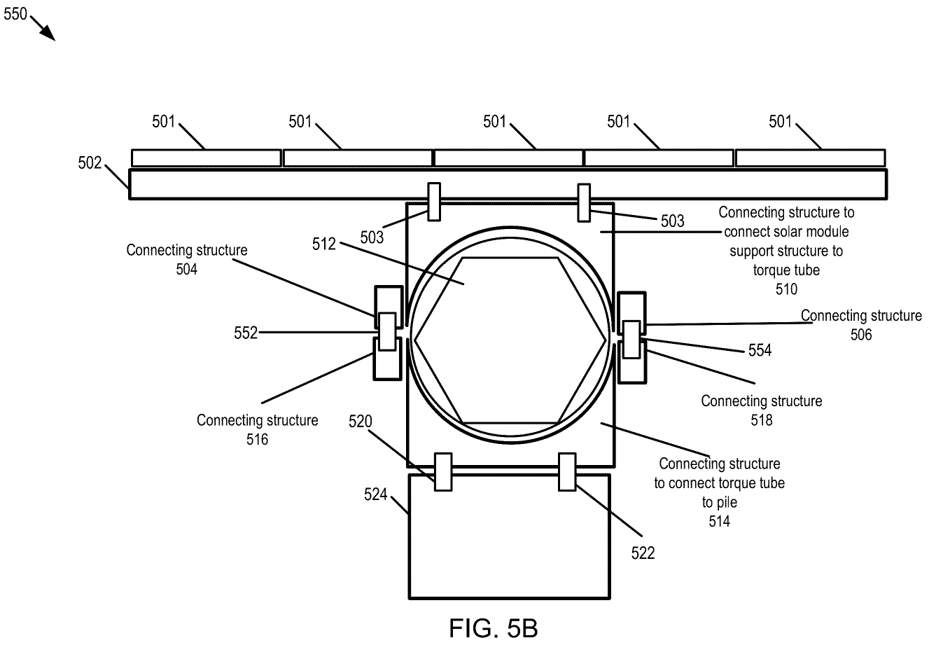

FIG. 5A is a schematic representation 500 of the solar modules 501 that are connected to a skeleton 502, which in turn is connected to connecting structure 510 (via bolts 503, or the like). Thus, FIG. 5A illustrates an example of the various connecting structures to connect the solar modules 501 (via the skeleton 502) to torque tube 512. The connection of connecting structure 510 to solar modules 501 (via skeleton 502) may be performed at the field factory prior to installation (via skeleton 502 and connecting structure 510) of the solar modules 501 onto the torque tube 512/pile 524, which were previously installed in the ground. Specifically, at the field factory, the solar modules 501 may be connected to the skeleton 502, which in turn may be connected to connecting structure 510. Alternatively, skeleton 502 may first be connected to connecting structure 510, and thereafter solar modules 501 may be connected to skeleton 502. In either instance, the various connections depicted in FIG. 5A (as well as other connections discussed herein) may be performed in one of several ways (either at the field factory and/or at the site), such as via bolts, bushings, or the like. Further, the connecting structure 510 may, in turn, include one or more structures that may be configured to connect to the torque tube 512 (or a mechanical structure associated with the torque tube 512) at the site. For example, FIG. 5A illustrates connecting structure 504, 506, which flank connecting structure 510, and may be used to connect connecting structure 510 to torque tube (e.g., by connecting or fastening connecting structures 504 to 516 and connecting structures 506 to 518, discussed below in FIG. 5B). Further, as shown in FIG. 5A, at the site, the pile 524 may be connected to the torque tube 512 (such as via connecting structure 514, which comprises a connecting structure to connect torque tube 512 to pile 524). In a first embodiment, at the site, the pile 524 may first be driven into the ground. After which, connecting structure 514 may be connected to pile 524 (such as via bolts 520, 522, or the like). Alternatively, bushing(s) may be used to connect the pile 524 to connecting structure 514. Thereafter, at the site, torque tube 512 may be connected to connecting structure 514. In a second embodiment, at the site, the pile 524 may be driven into the ground. Either before or after driving the pile 524 into the ground, connecting structure 514 may be connected to torque tube 512. After connecting the connecting structure 514 to torque tube 512, the combination may be connected to pile 524 (already driven into the ground). FIG. 5A further shows arrow 508, which indicates the placement of the solar modules 501 (via skeleton 502 and connecting structure 510) onto the torque tube 512.

FIG. 5B is a schematic representation 550 of the solar modules 501, skeleton 502, connecting structure 510, torque tube 512, and pile 524 previously installed in the ground. As shown, connecting structure 514 may, in turn, include one or more connecting structures 516, 518, which may be used to connect, respectively, with connecting structures 504, 506. In practice, after placing the solar modules 501, skeleton 502, connecting structure 510 onto the torque tube 512 on site, connecting structure 504 may be connected to connecting structure 516 (e.g., via one or more bolts 552, 554 or the like) and connecting structure 506 may be connected to connecting structure 518 (e.g., via bolt 554 or the like) on site. Alternatively, bushing(s) may be used instead of bolts 552, 554. In this regard, connections to the connecting structures discussed herein may be performed using one or more different types of connectors.

As discussed above, structure to connect the solar modules to the torque tubes and/or to connect the torque tubes to the piles may be installed at the field factory. As one example, FIG. 6A illustrates a configuration in which both: (i) the structure to connect the solar modules to the torque tubes and (ii) the structure to connect the torque tubes to the piles are installed at the field factory prior to transport to the site. In particular, FIG. 6A is a schematic representation 600 of the solar module/torque tube combination, with skeleton 502, bolts 503, and connecting structure 510 connecting solar modules 501 to torque tube 512. These connections may be made at the field factory. As discussed further below, surface 604 of connecting structure 602 may be placed onto surface 608 of pile 524 as shown by arrow 606.

It is noted that torque tube 512 is sandwiched between two connecting structures 510 and 602 so that torque tube 512 may connect, respectively to solar modules (via skeleton 502) and to piles 524. Alternatively, connecting structures 510, 602 may comprise a single unitary piece that may at least partly encircle, such as entirely encircle, torque tube 512.

FIG. 6B is a schematic representation 650 of the solar module/torque tube combination with the first example of the connecting structure 510 and the connecting structure 602 after installation onto the pile 524, previously installed in the ground. In particular, one or more bolts 652, 654 or the like may be used on site connect pile 524 to connecting structure 602. Alternatively, bushing(s) may be used to connect the pile 524 to connecting structure 602.

As another example, FIG. 7A is an illustration 700 of only the structure to connect the solar modules 501 to the torque tubes 512 being installed at the field factory prior to transport to the site, with the structure (along with the torque tubes 512) being installed to the piles 524 on site. In particular, FIG. 7A illustrates skeleton 502 and connecting structure 510 to connect solar modules 501 to torque tube 512. Further, FIG. 7A illustrates an additional structure to connect the torque tube (directly or indirectly) to the pile 524 (directly or indirectly). In particular, the additional structure may comprise connecting structure to pile 702, 704, which may be connected to connecting structure 510. Alternatively, a different structure may be attached at the field factory directly to torque tube 512, and thereafter connected to the piles 524 (either directly or indirectly) at the site. In practice, arrow 706 indicates the placement of the torque tube 512 onto the pile 524 (such as indirectly onto the pile 524 via connecting structure 712). For example, FIG. 7B is a schematic representation 750 of the solar module/torque tube combination after connection on site. In practice, pile 524 may be connected on site to connecting structure 712 via one or more bolts 714, 716 or the like. Thereafter, on site, connecting structure to pile 702 may be connected to connecting structure to torque tube 708 via one or more bolts 752 or the like, and connecting structure to pile 704 may be connected to connecting structure to torque tube 710 via bolt 754 or the like. Alternatively, bushing(s) may be used to connect the torque tube 512 to pile 524.

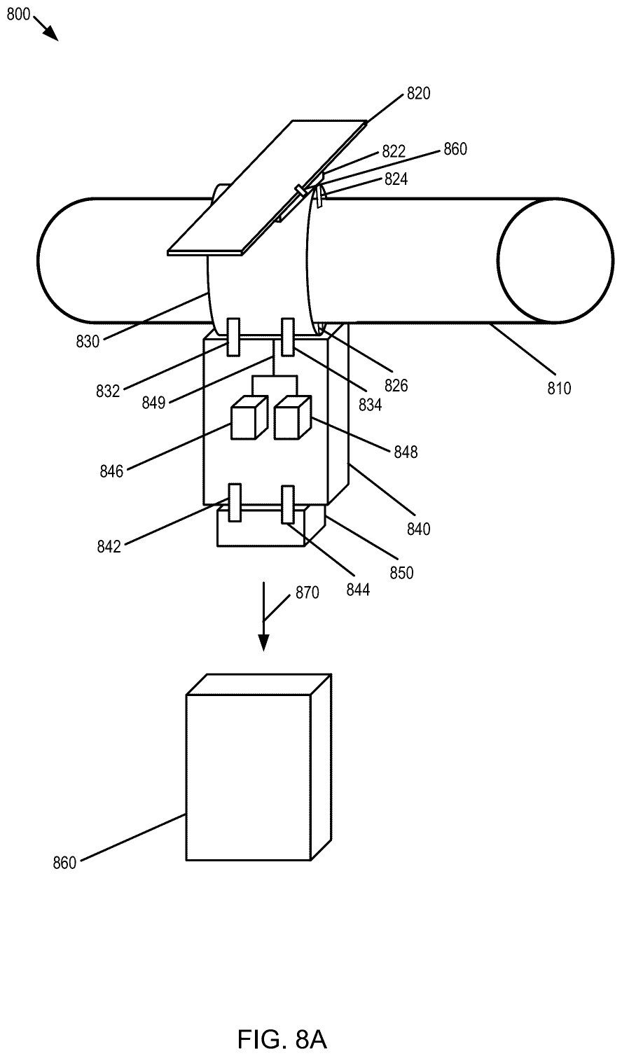

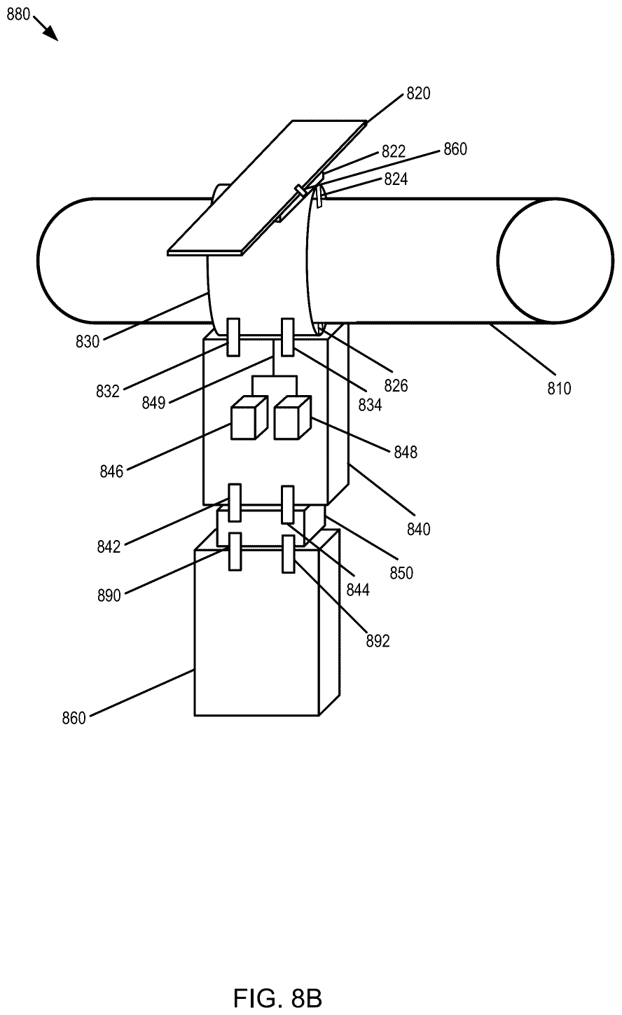

As discussed above, various assemblies may be connected to or work in combination with the torque tubes. As one example, a drive assembly may work in combination (and be connected to) the torque tubes. Typically, in a string of solar modules, a center pile (e.g., the pile that is positioned in the middle of the string of solar modules) may have associated with it a drive assembly that is configured to move, such as rotate, the torque tube to track the sun. In one or some embodiments, the drive assembly may include any one, any combination, or all of: one or more motors; control electronics (e.g., receive a command and responsive thereto, activate the one or more motors to rotate the torque tubes to track the sun; or sense a direction of the sun and responsive thereto, activate the one or more motors to rotate the torque tubes to track the sun); one or more mechanical drives (e.g., linear actuator, motorized slew, or the like); one or more connectors for connecting to the torque tubes; one or more connectors for connecting to the piles; or one or more power sources (e.g., battery, solar panel/electronics). Further, as discussed with regard to FIGS. 8A-B, in the field factory, one or more parts of the drive assembly, such as any one, any combination, or all of the following may be assembled therein: one or more motors; one or more mechanical actuators; one or more connectors for connecting to the torque tubes; or one or more power sources.

FIG. 8A is a schematic representation 800 of the torque tube/drive assembly combination prior to installation on pile 860 previously installed in the ground. Specifically, FIG. 8A illustrates the assembly at the field factory with the torque tube 810 being connected to drive assembly 840, such as via connector 830. In one or some embodiments, connector 830 may comprise an O-ring or the like, and may connect to torque tube 810 via one or more bolts 824, 826. Further, connector 830 may connect to drive assembly 840 via one or more bolts 832, 834. In turn, drive assembly 840, in preparation for connection with the pile 860 on site, may have attached thereto a connector 850, which may be connected to drive assembly 840 via one or more bolts 842, 844.

In one or some embodiments, drive assembly 840 may have a power source, such as a battery which may be resident within drive assembly 840. Alternatively, drive assembly 840 may receive its power from a solar module 820 attached to the torque tube, such as illustrated in FIG. 8A. In particular, solar module 820 (which may be smaller in size to solar module 501) may be connected to torque tube 810 via a platform 822 or the like (such as via one or more clips 860 that connect solar module 820 to platform 822). Further, platform 822 may be connected to torque tube 810, such as via one or more bolts 824. In this regard, in the field factory, the solar module 820 may be mechanically connected to the torque tube 810 (such as via platform 822). Alternatively, or in addition, the solar module 820 may be electrically connected at the field factory to drive assembly 840 so that power generated by solar module 820 may be routed (via wiring 849) to drive assembly 840 in order to power the electronics 846 and/or motor 848 resident within the drive assembly 840. Further, in one or some embodiments, the electrical connection of the wiring 849 may be tested in the field factory prior to transportation and installation at the site.

After movement at the site, arrow 870 shows the movement of the torque tube/drive assembly combination onto the pile 860, with FIG. 8B illustrating a schematic representation 880 of the torque tube/drive assembly combination after installation onto the pile 860 previously installed in the ground. As shown in FIG. 8B, only one or more bolts 890, 892 (or other connector) may be needed to mechanically connect the torque tube/drive assembly combination (via connector 850) to the pile 860.

As another example, a damper assembly may work in combination (and be connected to) the solar module(s). Typically, in a string of solar modules, one or both end piles (e.g., the piles that are positioned on either end of the string of solar modules) may have associated with it a damper assembly that is configured to dampen movement or reduce vibrations of one or more parts of the structure, such as reduce vibrations of the solar modules due to excessive wind. The damper assembly may include any one, any combination, or all of: one or more dampers (e.g., hydraulic damper or the like); one or more mechanical connectors to another device, such as to the structure associated with the solar module(s) (e.g., the skeleton supporting the solar module(s)); or one or more mechanical connectors to the pile. Further, as discussed with regard to FIGS. 8A-B, in the field factory, one or more parts of the damper assembly, such as any one or both of the following, may be assembled therein: one or more dampers and one or more mechanical connectors to another device.

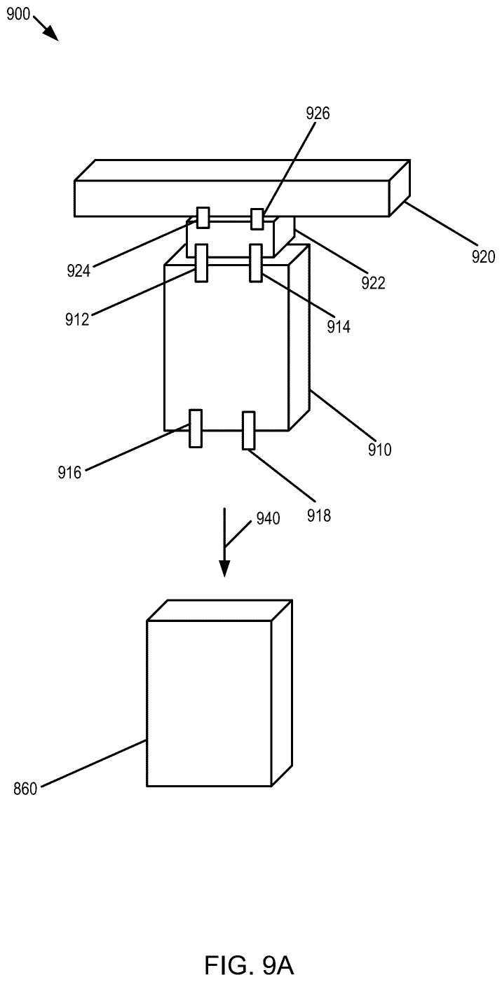

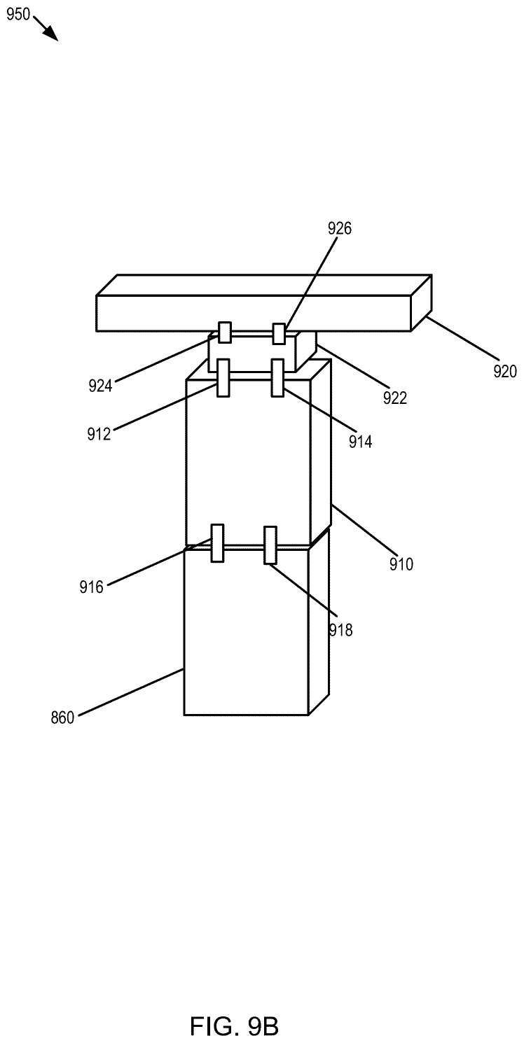

FIG. 9A is a schematic representation 900 of the solar module/damper assembly combination prior to installation on pile 860 previously installed in the ground. As discussed above, the damper assembly 910 may be configured to damper movement of the solar module(s). In one or some embodiments, the damper assembly 910 may have two separate attachments, including an upper damper attachment (embodied in one or more connections, such as one or more bolts or connectors 912, 914) and a lower damper attachment (embodied in one or more connections, such as one or more bolts or connectors 916, 918). In practice, the upper damper attachment may be connected to (such as via one or more intermediary structures) to the solar module(s) 920. For example, structure 922 (which may comprise a skeleton, such as discussed above), may be configured to provide mechanical structure or rigidity to solar module(s) 920. As such, connectors 912, 914 (acting as the upper damper attachment) may be connected to structure 922. In turn, connectors 916, 918 (acting as the lower damper attachment) may be connected (such as directly or via one or more intermediary structures) to the pile 860. As such, the mechanical assembly may be more efficiently performed.

After movement at the site, arrow 940 shows the movement of the solar module/damper assembly combination onto the pile 860, as illustrated in FIG. 9B, which is a schematic representation 950 of the solar module/damper assembly combination after installation onto the pile 860 previously installed in the ground, with only the one or more connectors 916, 918 needed to mechanically connect the solar module/damper assembly combination to the pile 860. Thus, in one or some embodiments, the one or more connectors 916, 918 may be connected to the damper assembly 910 at the field factory. Alternatively, the one or more connectors 916, 918 may be connected to the damper assembly 910 and to the pile 860 at the site. Alternatively, or in addition, an intermediate structural piece (between the damper assembly 910 and the pile 860) may be installed either at the field factory (similar to connector 850), with one or more bolts (or the like) being used to connect the intermediate structural piece to both the damper assembly 910 and to the pile 860.

In one or some embodiments, the field factory may be packaged in shipping containers that may be deployed one after the other, connected through doors on both ends to easily create the assembly line, where the materials may enter in one end of the field factory and pre-assembled torque tubes with the solar modules may exit the field factory at the other end.

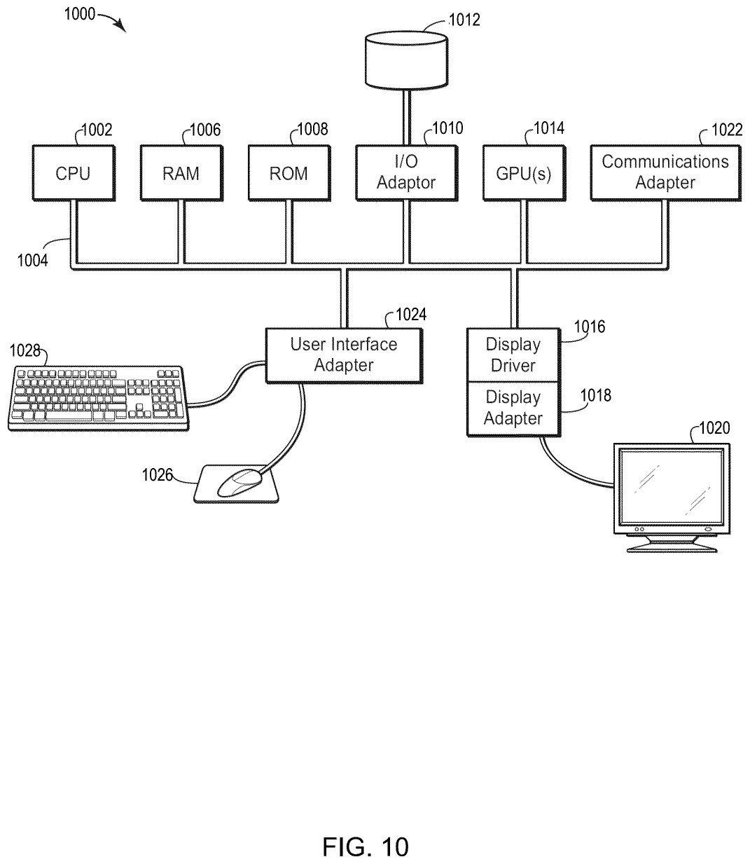

In all practical applications, the present technological advancement may (or must) be used in conjunction with a computer, programmed in accordance with the disclosures herein. Merely by way of example, various devices disclosed in the present application may comprise a computer or may work in combination with a computer (e.g., executed by a computer), such as any one, any combination, or all of the steps disclosed in FIGS. 1A-C and/or FIGS. 4A-B. In particular, any one, any combination, or all of the operations performed at the field factory may be control (such as automatically controlled) by computer(s). Merely by way of example, FIG. 10 is a diagram of an exemplary computer system 1000 that may be utilized to implement methods, including the flow diagrams, described herein. A central processing unit (CPU) 1002 is coupled to system bus 1004. The CPU 1002 may be any general-purpose CPU, although other types of architectures of CPU 1002 (or other components of exemplary computer system 1000) may be used as long as CPU 1002 (and other components of computer system 1000) supports the operations as described herein. Those of ordinary skill in the art will appreciate that, while only a single CPU 1002 is shown in FIG. 10, additional CPUs may be present. Moreover, the computer system 1000 may comprise a networked, multi-processor computer system that may include a hybrid parallel CPU/GPU system. The CPU 1002 may execute the various logical instructions according to various teachings disclosed herein. For example, the CPU 1002 may execute machine-level instructions for performing processing according to the operational flow described herein.

The computer system 1000 may also include computer components such as non-transitory, computer-readable media. Examples of computer-readable media include computer-readable non-transitory storage media, such as a random-access memory (RAM) 1006, which may be SRAM, DRAM, SDRAM, or the like. The computer system 1000 may also include additional non-transitory, computer-readable storage media such as a read-only memory (ROM) 1008, which may be PROM, EPROM, EEPROM, or the like. RAM 1006 and ROM 1008 hold user and system data and programs, as is known in the art. In this regard, computer-readable media may comprise executable instructions to perform any one, any combination, or all of the blocks in the flow charts in FIGS. 1A-C and/or FIGS. 4A-B. The computer system 1000 may also include an input/output (I/O) adapter 1010, a graphics processing unit (GPU) 1014, a communications adapter 1022, a user interface adapter 1024, a display driver 1016, and a display adapter 1018.

The I/O adapter 1010 may connect additional non-transitory, computer-readable media such as storage device(s) 1012, including, for example, a hard drive, a compact disc (CD) drive, a floppy disk drive, a tape drive, and the like to computer system 1000. The storage device(s) may be used when RAM 1006 is insufficient for the memory requirements associated with storing data for operations of the present techniques. The data storage of the computer system 1000 may be used for storing information and/or other data used or generated as disclosed herein. For example, storage device(s) 1012 may be used to store configuration information or additional plug-ins in accordance with the present techniques. Further, user interface adapter 1024 couples user input devices, such as a keyboard 1028, a pointing device 1026 and/or output devices to the computer system 1000. The display adapter 1018 is driven by the CPU 1002 to control the display on a display device 1020 to, for example, present information to the user such as images generated according to methods described herein.

The architecture of computer system 1000 may be varied as desired. For example, any suitable processor-based device may be used, including without limitation personal computers, laptop computers, computer workstations, and multi-processor servers. Moreover, the present technological advancement may be implemented on application specific integrated circuits (ASICs) or very large scale integrated (VLSI) circuits. In fact, persons of ordinary skill in the art may use any number of suitable hardware structures capable of executing logical operations according to the present technological advancement. The term “processing circuit” encompasses a hardware processor (such as those found in the hardware devices noted above), ASICs, and VLSI circuits. Input data to the computer system 1000 may include various plug-ins and library files. Input data may additionally include configuration information.

It is intended that the foregoing detailed description be understood as an illustration of selected forms that the invention can take and not as a definition of the invention. It is only the following claims, including all equivalents which are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented.

The following example embodiments of the invention are also disclosed:

### Embodiment 1

A method of installing solar modules at a solar panel site, the method comprising:
driving a set of piles into a ground at the solar panel site;
connecting, at the solar panel site, torque tubes to the piles;
receiving, at a field factory locationally separate from the solar panel site, solar modules;
electrically and mechanically connecting, at the field factory, the solar modules together to form a string or a sub-string of solar modules;
electrically testing, at the field factory, the electrical connections in the string or sub-string of solar modules;
transporting, from the field factory to the solar panel site, the string or sub-string of solar modules;
mechanically connecting, at the solar panel site, the string or sub-string of solar modules to the torque tubes;
electrically connecting, at the solar panel site, the string or sub-string of solar modules to other strings of solar modules or other sub-strings of solar modules, or to power electronics; and
electrically testing, at the solar panel site, the electrical connections.

### Embodiment 2

The method of embodiment 1: wherein mechanically connecting the solar modules together comprises mechanically connecting a plurality of solar modules to a skeleton structure;
wherein the plurality of solar modules are electrically connected together to form a sub-string of solar modules; and
wherein mechanically connecting the sub-string of solar modules to the torque tubes comprises mechanically connecting at least one torque tube to the skeleton structure.

### Embodiment 3

The method of embodiments 1 or 2: wherein a plurality of sub-strings of solar modules are transported by truck from the field factory to the solar panel site;
wherein the piles are formed in lines; and
wherein the truck drives in between the lines and uses a robotic arm connected to the truck to place the plurality of sub-strings of solar modules onto the torque tubes.

### Embodiment 4

The method of any of embodiments 1-3: wherein the robotic arm moves the plurality of sub-strings of solar modules from the truck to place them on the torque tubes by physically grabbing the skeleton structure of the plurality of sub-strings of solar modules.

### Embodiment 5

The method of any of embodiments 1-4: wherein a plurality of sub-strings of solar modules are connecting to the torque tubes;
wherein the plurality of sub-strings of solar modules are electrically connected together to form a string of solar modules; and
wherein electrically testing the electrical connections comprises electrically testing the electrical connections between the plurality of sub-strings.

### Embodiment 6

The method of any of embodiments 1-5: further comprising connecting and testing, at the field factory, sensor electronics to the solar modules that form the string or the sub-string of solar modules.

### Embodiment 7

A method of installing solar modules at a solar panel site, the method comprising:
driving a set of piles into a ground at the solar panel site;
connecting one or more solar modules onto one or more torque tubes to form one or more solar module-torque tube combinations;
after forming the one or more solar module-torque tube combinations, connecting the one or more solar module-torque tube combinations to one or more of the piles; and
connecting wiring between the one or more solar module-torque tube combinations.

### Embodiment 8

The method of embodiment 7: wherein connecting the one or more solar modules onto the one or more torque tubes to form the one or more solar module-torque tube combinations is performed at a field factory locationally separate from the solar panel site.

### Embodiment 9

The method of embodiments 7 or 8: further comprising transporting the one or more solar module-torque tube combinations by truck from the field factory to the solar panel site for installation onto the one or more piles.

### Embodiment 10

The method of any of embodiments 7-9: further comprising using one or more robots in order to transfer the one or more solar module-torque tube combinations from the truck to the one or more piles for installation.

### Embodiment 11

The method of any of embodiments 7-10: further comprising after forming the one or more solar module-torque tube combinations but before connection to the one or more piles:
installing wiring in or to the one or more solar module-torque tube combinations; and
testing the wiring.

### Embodiment 12

The method of any of embodiments 7-11: further comprising after connecting the one or more solar module-torque tube combinations the one or more piles:
testing the wiring between the one or more solar module-torque tube combinations.

### Embodiment 13

The method of any of embodiments 7-12: wherein the one or more solar module-torque tube combinations comprise a connecting structure to connect the solar module to the torque tube; and
wherein connecting the one or more solar modules onto one or more torque tubes to form one or more solar module-torque tube combinations comprises installing the connecting structure to connect the solar module to the torque tube thereby connecting the solar module to the torque tube at the field factory.

### Embodiment 14

The method of any of embodiments 7-13: further comprising, at the field factory, installing a connecting structure to connect the torque tube to the pile.

### Embodiment 15

The method of any of embodiments 7-14: wherein, at the solar panel site, the connecting structure to connect the torque tube to the pile a field factory is used to connect the torque tube with the pile.

### Embodiment 16

The method of any of embodiments 7-15: further comprising, at the solar panel site, installing a connecting structure to connect the torque tube to the pile.

### Embodiment 17

The method of any of embodiments 7-16: wherein the pile is driven into the ground at the solar panel site;
after driving the pile into the ground, installing the connecting structure to connect the torque tube to the pile; and
after installing the connecting structure to connect the torque tube to the pile, installing the solar module-torque tube combination using the connecting structure to connect the torque tube to the pile in order to connect the solar module-torque tube combination to the pile.

### Embodiment 18

The method of any of embodiments 7-17: further comprising, at the field factory, installing clamps onto the one or more torque tubes; and
wherein connecting the one or more solar modules onto the one or more torque tubes to form the one or more solar module-torque tube combinations is using the clamps.

### Embodiment 19

The method of any of embodiments 7-18: further comprising:
automated unloading of materials at the field factory; and
assembling, at the field factory using the materials, the one or more solar modules and the one or more torque tubes.

### Embodiment 20

The method of any of embodiments 7-19: further comprising:
mechanically connecting, at the field factory, a drive assembly to at least one torque tube to form a drive assembly-torque tube combination, wherein the drive assembly is configured to rotate the at least one torque tube;
mechanically connecting, at the field factory, at least one solar module to the at least one torque tube;
electrically connecting, at the field factory, the at least one solar module to one or more parts of the drive assembly in order to power the one or more parts of the drive assembly;
transporting, to the solar panel site, the drive assembly-torque tube combination with the at least one solar module connected to the torque tube; and
mechanically connecting to at least one pile the drive assembly-torque tube combination with the at least one solar module connected to the torque tube.

### Embodiment 21

The method of any of embodiments 7-20: further comprising electrically testing, at the field factory, the electrical connection of the at least one solar module to the one or more parts of the drive assembly.

### Embodiment 22

The method of any of embodiments 7-21: wherein the drive assembly comprises a connector configured for connection to the at least one pile; and
wherein mechanically connecting of the drive assembly-torque tube combination at the solar panel site consists of:
   placing the drive assembly-torque tube combination onto the at least one pile; and
   connecting the connector of the drive assembly to the at least one pile.

### Embodiment 23

The method of any of embodiments 7-22: further comprising:
mechanically connecting, at the field factory, a damper assembly to at least one structure supporting at least one solar module to form a solar module-damper assembly combination, wherein the damper assembly is configured to dampen movement of one or more of the solar modules;
transporting, to the solar panel site, the solar module-damper assembly combination; and
mechanically connecting to at least one pile the damper assembly-solar module combination.

### Embodiment 24

The method of any of embodiments 7-23: wherein the damper assembly comprises a connector configured for connection to the at least one pile; and
wherein mechanically connecting of the solar module-damper assembly combination at the solar panel site consists of:
   placing the solar module-damper assembly combination onto the at least one pile; and
   connecting the damper assembly to the at least one pile.

### Embodiment 25

The method of any of embodiments 7-24: wherein mechanically connecting, at the field factory, the one or more solar modules onto the one or more torque tubes to form one or more solar module-torque tube combinations includes aligning the one or more solar modules within a skeleton structure upon which the one or more solar modules are supported or aligning the skeleton structure to at least one torque tube; and
wherein leveling is performed at the solar panel site.

### Embodiment 26

The method of any of embodiments 7-25: wherein alignment of the one or more solar modules is performed entirely at the field factory; and
wherein leveling is performed entirely at the solar panel site.

### Embodiment 27

The method of any of embodiments 7-26: wherein one or more jigs are used to perform the aligning of the one or more solar modules within the skeleton structure or the aligning of the skeleton structure to the at least one torque tube.

What is claimed is:

1. A method of installing solar modules at a solar panel site, the method comprising:
driving a set of piles into a ground at the solar panel site;
connecting, at the solar panel site, torque tubes to the piles;
receiving, at a field factory locationally separate from the solar panel site, solar modules;
electrically and mechanically connecting, at the field factory, the solar modules together to form a string or a sub-string of solar modules;
electrically testing, at the field factory, the electrical connections in the string or sub-string of solar modules;
transporting, from the field factory to the solar panel site, the string or sub-string of solar modules;
mechanically connecting, at the solar panel site, the string or sub-string of solar modules to the torque tubes;
electrically connecting, at the solar panel site, the string or sub-string of solar modules to other strings of solar modules or other sub-strings of solar modules, or to power electronics; and
electrically testing, at the solar panel site, the electrical connections.

2. The method of claim 1, wherein mechanically connecting the solar modules together comprises mechanically connecting a plurality of solar modules to a skeleton structure;
wherein the plurality of solar modules are electrically connected together to form a sub-string of solar modules; and
wherein mechanically connecting the sub-string of solar modules to the torque tubes comprises mechanically connecting at least one torque tube to the skeleton structure.

3. The method of claim 2, wherein a plurality of sub-strings of solar modules are transported by truck from the field factory to the solar panel site;
wherein the piles are formed in lines; and
wherein the truck drives in between the lines and uses a robotic arm connected to the truck to place the plurality of sub-strings of solar modules onto the torque tubes.

4. The method of claim 3, wherein the robotic arm moves the plurality of sub-strings of solar modules from the truck to place them on the torque tubes by physically grabbing the skeleton structure of the plurality of sub-strings of solar modules.

5. The method of claim 4, wherein a plurality of sub-strings of solar modules are connecting to the torque tubes;
wherein the plurality of sub-strings of solar modules are electrically connected together to form a string of solar modules; and
wherein electrically testing the electrical connections comprises electrically testing the electrical connections between the plurality of sub-strings.

6. The method of claim 5, further comprising connecting and testing, at the field factory, sensor electronics to the solar modules that form the string or the sub-string of solar modules.

7. A method of installing solar modules at a solar panel site, the method comprising:
driving a set of piles into a ground at the solar panel site;
connecting one or more solar modules onto one or more torque tubes to form one or more solar module-torque tube combinations;
after forming the one or more solar module-torque tube combinations, connecting the one or more solar module-torque tube combinations to one or more of the piles; and
connecting wiring between the one or more solar module-torque tube combinations.

8. The method of claim 7, wherein connecting the one or more solar modules onto the one or more torque tubes to form the one or more solar module-torque tube combinations is performed at a field factory locationally separate from the solar panel site.

9. The method of claim 8, further comprising transporting the one or more solar module-torque tube combinations by truck from the field factory to the solar panel site for installation onto the one or more piles.

10. The method of claim 9, further comprising using one or more robots in order to transfer the one or more solar module-torque tube combinations from the truck to the one or more piles for installation.

11. The method of claim 8, further comprising after forming the one or more solar module-torque tube combinations but before connection to the one or more piles:
installing wiring in or to the one or more solar module-torque tube combinations; and
testing the wiring.

12. The method of claim 11, further comprising after connecting the one or more solar module-torque tube combinations the one or more piles:
testing the wiring between the one or more solar module-torque tube combinations.

13. The method of claim 8, wherein the one or more solar module-torque tube combinations comprise a connecting structure to connect the solar module to the torque tube; and
wherein connecting the one or more solar modules onto one or more torque tubes to form one or more solar module-torque tube combinations comprises installing the connecting structure to connect the solar module to the torque tube thereby connecting the solar module to the torque tube at the field factory.

14. The method of claim 13, further comprising, at the field factory, installing a connecting structure to connect the torque tube to the pile; and
wherein, at the solar panel site, the connecting structure to connect the torque tube to the pile a field factory is used to connect the torque tube with the pile.

15. The method of claim 13, further comprising, at the solar panel site, installing a connecting structure to connect the torque tube to the pile;
wherein the pile is driven into the ground at the solar panel site;
after driving the pile into the ground, installing the connecting structure to connect the torque tube to the pile; and
after installing the connecting structure to connect the torque tube to the pile, installing the solar module-torque tube combination using the connecting structure to connect the torque tube to the pile in order to connect the solar module-torque tube combination to the pile.

16. The method of claim 8, further comprising, at the field factory, installing clamps onto the one or more torque tubes; and
wherein connecting the one or more solar modules onto the one or more torque tubes to form the one or more solar module-torque tube combinations is using the clamps.

17. The method of claim 8, further comprising:
automated unloading of materials at the field factory; and
assembling, at the field factory using the materials, the one or more solar modules and the one or more torque tubes.

18. The method of claim 8, further comprising:
mechanically connecting, at the field factory, a drive assembly to at least one torque tube to form a drive assembly-torque tube combination, wherein the drive assembly is configured to rotate the at least one torque tube;
mechanically connecting, at the field factory, at least one solar module to the at least one torque tube;
electrically connecting, at the field factory, the at least one solar module to one or more parts of the drive assembly in order to power the one or more parts of the drive assembly;
transporting, to the solar panel site, the drive assembly-torque tube combination with the at least one solar module connected to the torque tube; and
mechanically connecting to at least one pile the drive assembly-torque tube combination with the at least one solar module connected to the torque tube.

19. The method of claim 18, further comprising electrically testing, at the field factory, the electrical connection of the at least one solar module to the one or more parts of the drive assembly;
wherein the drive assembly comprises a connector configured for connection to the at least one pile; and
wherein mechanically connecting of the drive assembly-torque tube combination at the solar panel site consists of:
placing the drive assembly-torque tube combination onto the at least one pile; and
connecting the connector of the drive assembly to the at least one pile.

20. The method of claim 8, further comprising:
mechanically connecting, at the field factory, a damper assembly to at least one structure supporting at least one solar module to form a solar module-damper assembly combination, wherein the damper assembly is configured to dampen movement of one or more of the solar modules;
transporting, to the solar panel site, the solar module-damper assembly combination; and
mechanically connecting to at least one pile the damper assembly-solar module combination.

21. The method of claim 20, wherein the damper assembly comprises a connector configured for connection to the at least one pile; and
wherein mechanically connecting of the solar module-damper assembly combination at the solar panel site consists of:
placing the solar module-damper assembly combination onto the at least one pile; and
connecting the damper assembly to the at least one pile.

22. The method of claim 8, wherein mechanically connecting, at the field factory, the one or more solar modules onto the one or more torque tubes to form one or more solar module-torque tube combinations includes aligning the one or more solar modules within a skeleton structure upon which the one or more solar modules are supported or aligning the skeleton structure to at least one torque tube; and
wherein leveling is performed at the solar panel site.

23. The method of claim 22, wherein alignment of the one or more solar modules is performed entirely at the field factory; and
wherein leveling is performed entirely at the solar panel site.

24. The method of claim 22, wherein one or more jigs are used to perform the aligning of the one or more solar modules within the skeleton structure or the aligning of the skeleton structure to the at least one torque tube.
